(19) United States
(12) Patent Application Publication
(10) Pub. No.: US 2026/0032767 A1
(43) Pub. Date: Jan. 29, 2026

(54) MANAGING DISCONTINUOUS RECEPTION OF MULTICAST AND/OR BROADCAST SERVICES

(71) Applicant: GOOGLE LLC, Mountain View, CA (US)

(72) Inventor: Chih-Hsiang Wu, Taoyuan City (TW)

(21) Appl. No.: 18/992,406

(22) PCT Filed: Jul. 6, 2023
(86) PCT No.: PCT/US2023/026975

§ 371 Date: Jan. 8, 2025

Related U.S. Application Data
(60) Provisional application No. 63/359,826, filed on Jul. 9, 2022.

(51) Int. Cl. H04W 76/28; H04W 76/40

(52) U.S. Cl. CPC H04W 76/28; H04W 76/40

(57) ABSTRACT

A user equipment participating in a multicast and broadcast services (MBS) session can implement a method for managing discontinuous reception (DRX) for the MBS session. The method includes: (i) receiving, by processing hardware, an MBS session transmission including a DRX command; (ii) determining, by the processing hardware, whether the DRX command pertains to a multicast DRX cycle or a unicast DRX cycle; and (iii) modifying, by the processing hardware and in accordance with the determining, a DRX operation of the UE.

### CROSS-REFERENCE TO RELATED APPLICATIONS

This application claims priority to and the benefit of the filing date of provisional U.S. Patent Application No. 63/359,826 entitled “MANAGING DISCONTINUOUS RECEPTION OF MULTICAST AND/OR BROADCAST SERVICES,” filed on Jul. 9, 2022. The entire contents of the provisional application are hereby expressly incorporated herein by reference.

### FIELD OF THE DISCLOSURE

This disclosure relates to wireless communications and, more particularly, to enabling discontinuous reception of one or more multicast and/or broadcast services (MBS) via multicast transmission.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Base stations that operate according to fifth-generation (5G) New Radio (NR) requirements support significantly larger bandwidth than fourth-generation (4G) base stations. Accordingly, the Third Generation Partnership Project (3GPP) has proposed that, for Release 15, user equipment units (UEs) support a 100 MHz bandwidth in frequency range 1 (FR1) and a 400 MHz bandwidth in frequency range 2 (FR2). The 5G NR system enables resource efficient delivery of multicast/broadcast services (MBS). For broadcast communication services, the same service and the same specific content data are provided simultaneously to all UEs in a geographical area (i.e., all UEs in the broadcast service area are authorized to receive the data). A base station delivers broadcast communication service to the UEs using a broadcast session. A UE can receive a broadcast communication service in RRC_IDLE, RRC_INACTIVE and RRC_CONNECTED state.

For multicast communication services, the same service and the same specific content data are provided simultaneously to a dedicated set of UEs (i.e., not all UEs in the multicast service area are authorized to receive the data). A base station delivers a multicast communication service to the UEs using a multicast session. 5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface. On the other hand, in PTM communications, a RAN node transmits a single copy of each MBS data packet to multiple UEs over the radio interface according to a discontinuous reception (DRX) cycle.

DRX is a feature IoT or MTC devices use to reduce power consumption. With the DRX mechanism, a user device can go into a sleep mode for a certain period (e.g., an off-duration period) and then wake up after the off-duration period to monitor the DL signal from the base station (e.g., an on-duration period). The DRX cycle defines the time interval between two consecutive time periods when the UE is awake. In some scenarios, however, it is unclear how a base station should configure DRX for one or more UEs to receive MBS data via multicast communication.

### SUMMARY

A UE manages discontinuous reception (DRX) for a multicast and broadcast services (MBS) session. The UE joins the MBS session and subsequently receives, from a node of a radio access network (RAN), a transmission through the MBS session including a DRX command from the MBS session transmission. The UE then determines whether the DRX command pertains to a multicast DRX cycle or a unicast DRX cycle. Depending on the implementation, the UE then modifies a DRX operation of the UE in accordance with the DRX command based on the determination.

A RAN node similarly manages DRX for the MBS session. In particular, the RAN node determines to transmit a DRX command, such as a command to stop a DRX on-duration, to a UE. The RAN node generates the DRX command and subsequently selects a transmission scheme for transmitting the DRX command, such as whether to scramble a cyclic redundancy check (CRC) using an MBS-specific RNTI or a UE-specific RNTI, based at least on a type of DRX operation. The RAN then transmits the DRX command via an MBS session transmission in accordance with the selected transmission scheme.

One example embodiment of these techniques is a method, implemented in a UE, for managing DRX for an MBS session. The method includes receiving, by processing hardware, an MBS session transmission including a DRX command; determining, by the processing hardware, whether the DRX command pertains to a multicast DRX cycle or a unicast DRX cycle; and modifying, by the processing hardware and in accordance with the determining, a DRX operation of the UE.

Another example embodiment of these techniques is a method for managing DRX for an MBS session, the method implemented in a RAN. The method includes generating, by processing hardware, a DRX command to modify DRX operation at a UE participating in an MBS session; selecting, by the processing hardware and based on a type of the DRX operation, a transmission scheme for providing the DRX command to the UE; and transmitting, by the processing hardware, the DRX command to the UE in accordance with the selected transmission scheme.

### BRIEF DESCRIPTION OF THE DRAWINGS

FIG. 1A is a block diagram of an example system in which the techniques of this disclosure for managing DRX for an MBS session may be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram of example tunnel architectures for MBS sessions and PDU sessions;

FIG. 4 is a block diagram of example tunnel architectures for MRBs and DRBs;

FIG. 5A is a messaging diagram of an example scenario in which a distributed base station of FIGS. 1A and/or 1B manage the transmission of a DRX cycle configuration data for an MBS session within the distributed base station and to a UE;

FIG. 5B is a messaging diagram of an example scenario similar to the scenario of FIG. 5A, but in which the CU is preconfigured with data information corresponding to configuring DRX;

FIG. 5C is a messaging diagram of an example scenario similar to the scenario of FIG. 5A, but in which the CU transmits a request for and subsequently receives data information corresponding to configuring DRX;

FIG. 5D is a messaging diagram of an example scenario similar to the scenario of FIG. 5A, but in which the CU receives an update from the CN including data information corresponding to configuring DRX;

FIG. 5E is a messaging diagram of an example scenario similar to the scenario of FIG. 5A, but in which the CU receives data information corresponding to configuring DRX from the CN prior to performing the MBS session configuration procedure;

FIG. 5F is a messaging diagram of an example scenario similar to the scenario of FIG. 5A, but in which the distributed base station manages multiple MBS sessions for multiple UEs;

FIG. 6A is a timing diagram of an example scenario in which an on-duration is cut short by a DRX command, and the on-duration of a unicast DRX cycle and the on-duration of a multicast DRX cycle for a UE in an MBS session do not overlap;

FIG. 6B is a timing diagram of an example scenario similar to the scenario of FIG. 6A, but in which the on-duration of the unicast DRX cycle and the on-duration of the multicast DRX cycle overlap;

FIG. 7 is a flow diagram of an example method, implemented in a UE, for receiving a DCI and a CRC scrambled by an MBS-specific RNTI, subsequently receiving a DRX command, and stopping an on-duration period in response;

FIG. 8 is a flow diagram of an example method, implemented in a UE for determining whether to stop an on-duration period of a multicast DRX cycle or a unicast DRX cycle based on whether the CRC is scrambled with an MBS-specific RNTI or a UE-specific RNTI;

FIG. 9 is a flow diagram of an example method, implemented in a PHY layer of a UE, for receiving a DCI and a CRC scrambled by an MBS-specific RNTI, subsequently receiving a MAC PDU, and transmitting the MAC PDU to an upper layer;

FIG. 10 is a flow diagram of an example method, implemented in a PHY layer of a UE, for determining whether to transmit a multicast indication based on whether a downlink transmission from the RAN is a multicast transmission;

FIG. 11 is a flow diagram of an example method, implemented in a PHY layer of a UE, for determining whether to transmit a transmission type indication to an upper layer based on whether a transmission type indication function is enabled;

FIG. 12 is a flow diagram of an example method, implemented in a MAC layer of a UE, for determining whether to stop an on-duration period of a multicast DRX cycle or a unicast DRX cycle based on whether the MAC PDU is received in a multicast or unicast transmission;

FIG. 13 is a flow diagram of an example method, implemented in a RAN node, for generating a DCI and scrambling a CRC with an MBS-specific RNTI and transmitting the DCI and CRC to UEs in the MBS session;

FIG. 14 is a flow diagram of an example method, implemented in a RAN node, for determining whether to generate a DCI and scramble a CRC according to an MBS-specific RNTI or a UE-specific RNTI based at least on whether the DRX operation is multicast or unicast;

FIG. 15 is a flow diagram of an example method, implemented in a RAN node, for generating and transmitting a MAC PDU using SPS multicast resources;

FIG. 16 is a flow diagram of an example method, implemented in a UE, for managing DRX for MBS; and

FIG. 17 is a flow diagram of an example method, implemented in a RAN node, for managing DRX for MBS.

### DETAILED DESCRIPTION OF THE DRAWINGS

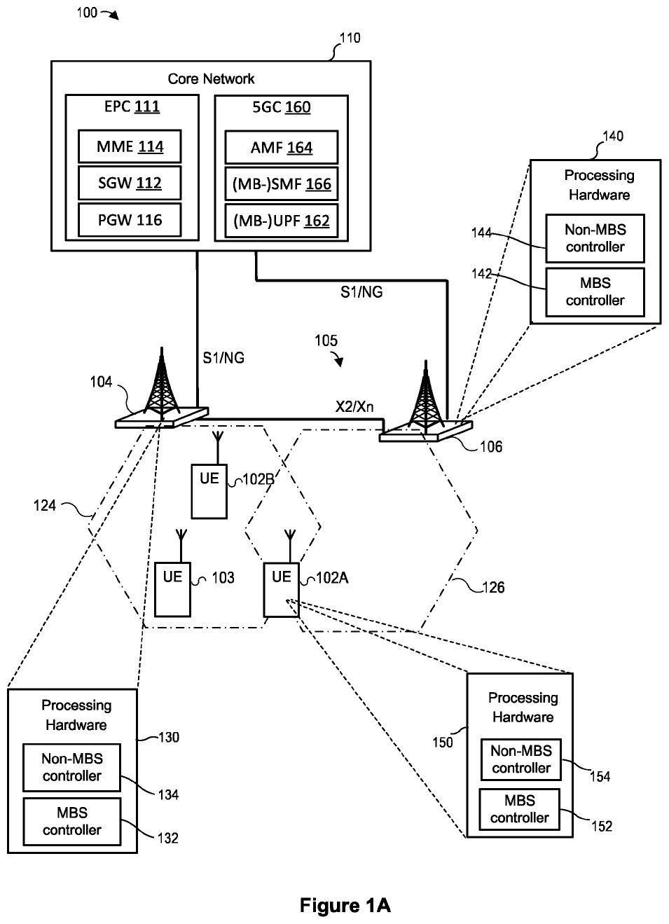

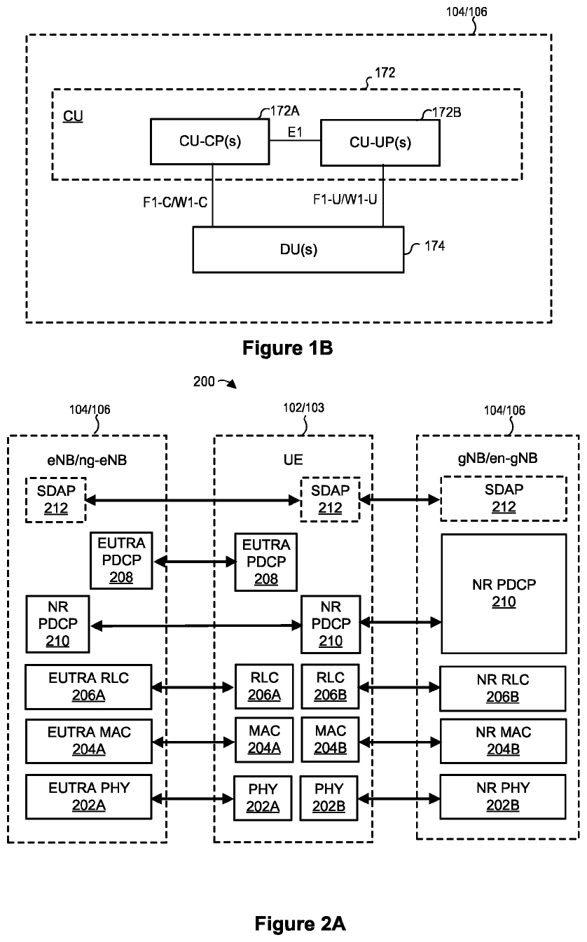

FIG. 1A depicts an example wireless communication system 100 capable of implementing techniques of this disclosure for managing transmission and reception of multicast and/or broadcast services (MBS) information. The wireless communication system 100 includes user equipment (UEs) 102A, 102B, and 103 as well as base stations 104, 106 of a radio access network (RAN) 105 connected to a core network (CN) 110. In other implementations or scenarios, the wireless communication system 100 includes more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows various dual connectivity (DC) scenarios. For example, the UE 102A can communicate in DC with the base station 104 (operating as a master node (MN)) and the base station 106 (operating as a secondary node (SN)).

In non-MBS (unicast) operation, the UE 102A can use a radio bearer (e.g., a DRB or an SRB) that, at different times, terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UE 102A can receive paging, system information, public warning message(s), or a random access response on the DL BWP.

In MBS operation, the UE 102A can use an MBS radio bearer (MRB) that, at different times, terminates at an MN (e.g., the base station 104) or an SN (e.g., the base station 106). For example, after handover or SN change, the UE 102A can use an MRB that terminates at the base station 106, which operates as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A, via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures, and messaging associated with MBS procedures, and/or other operations associated with those configurations and/or procedures, including a HARQ process, as discussed below. In some implementations, the processing hardware 130 also includes a non-MBS controller 134 that is configured to manage or control one or more RRC configurations and/or RRC procedures when the base station 104 operates as an MN or SN during a non-MBS operation.

The base station 106 includes processing hardware 140, which, in some implementations, includes one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, in further implementations the RAN 105 includes additional base stations with processing hardware similar to the processing hardware 130 of the base station 104 and/or the processing hardware 140 of the base station 106.

The UE 102A includes processing hardware 150, which, in some implementations, includes one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the UE MBS controller 152 can be configured to support RRC configurations, procedures, and messaging associated with MBS procedures, and/or other operations associated with those configurations and/or procedures, including a HARQ process, as discussed below. The processing hardware 150 in further implementations also includes a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, in further implementations, UEs 102B and 103 include processing hardware similar to the processing hardware 150 of the UE 102A.

In some implementations, the CN 110 is an evolved packet core (EPC) 111 or a fifth-generation core (5GC) 160, both of which are depicted in FIG. 1A. Depending on the implementation, the base station 104 is an eNB supporting an S1 interface for communicating with the EPC 111, an ng-eNB supporting an NG interface for communicating with the 5GC 160, or a gNB that supports an NR radio interface as well as an NG interface for communicating with the 5GC 160. In further implementations, the base station 106 is an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or an ng-eNB that supports an EUTRA radio interface and an NG interface to the 5GC 160. In some implementations, to directly exchange messages with each other during the scenarios discussed below, the base stations 104 and 106 support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, in some implementations, the wireless communication system 100 includes any suitable number of base stations supporting NR cells and/or EUTRA cells. More particularly, in further implementations, the EPC 111 or the 5GC 160 connect to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

FIG. 1B depicts an example distributed implementation of any one or more of the base stations 104 and 106. In this implementation, the base station 104 or 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DUs 174 also includes processing hardware that includes one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. In further implementations, the processing hardware also includes a physical (PHY) layer controller configured to manage or control one or more PHY layer operations or procedures.

In some implementations, the CU 172 includes one or more logical nodes (CU-CP(s) 172A) that host the control plane part of the Packet Data Convergence Protocol (PDCP) protocol of the CU 172 and/or the radio resource control (RRC) protocol of the CU 172. The CU 172 also includes, in further implementations, one or more logical nodes (CU-UP(s) 172B) that host the user plane part of the PDCP protocol and/or service data adaptation protocol (SDAP) protocol of the CU 172. The CU-CP(s) 172A transmit non-MBS control information and/or MBS control information, and the CU-UP(s) 172B transmit non-MBS data packets and/or MBS data packets, as described herein.

In some implementations, the CU-CP(s) 172A connect to multiple CU-UPs 172B through the E1 interface. The CU-CP(s) 172A select the appropriate CU-UP(s) 172B for the requested services for the UE 102A. In some implementations, a single CU-UP 172B connects to multiple CU-CPs 172A through the E1 interface. In further implementations, a CU-CP 172A connects to one or more DUs 174s through an F1-C interface. Similarly, in further implementations, a CU-UP 172B connects to one or more DUs 174 through an F1-U interface under the control of the same CU-CP 172A. In some implementations, one DU 174 connects to multiple CU-UPs 172B under the control of the same CU-CP 172A. In such implementations, the connectivity between a CU-UP 172B and a DU 174 is established by the CU-CP 172A using bearer context management functions.

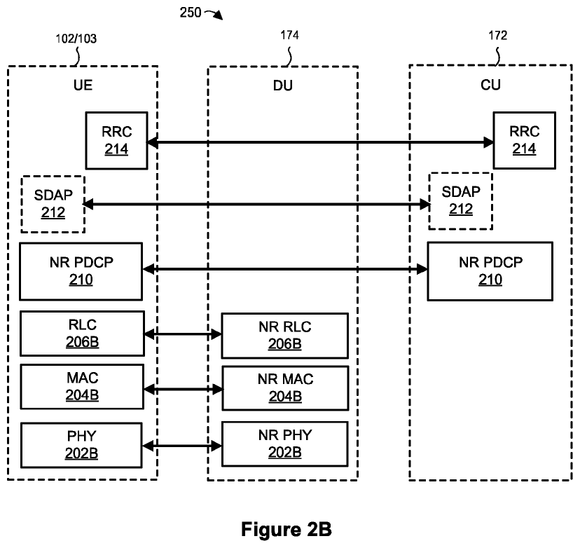

FIG. 2A illustrates, in a simplified manner, an example protocol stack 200 according to which a UE (e.g., UE 102A, 102B, or 103) communicates with an eNB/ng-eNB or a gNB (e.g., one or more of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE 102A, in some implementations, supports both the EUTRA and the NR stack as shown in FIG. 2A, to support handover between EUTRA and NR base stations and/or to support DC over EUTRA and NR interfaces. Further, as illustrated in FIG. 2A, in some implementations the UE 102A supports layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that are referred to as service data units (SDUs), and output packets (e.g., to the RLC layer 206A or 206B) that are referred to as protocol data units (PDUs). Except where the difference between SDUs and PDUs is relevant, this disclosure for simplicity refers to both SDUs and PDUs as “packets.” Depending on the implementation, the packets can be MBS packets or non-MBS packets. In some implementations, MBS packets include application content for an MBS service (e.g., IPv4/IPv6 multicast delivery, IPTV, software delivery over wireless, group communications, IoT applications, V2X applications, and/or emergency messages related to public safety), for example. As another example, MBS packets include application control information for the MBS service.

On a control plane, the EUTRA PDCP sublayer 208 and the NR PDCP sublayer 210 provide SRBs to exchange RRC messages or non-access-stratum (NAS) messages, for example. On a user plane, the EUTRA PDCP sublayer 208 and the NR PDCP sublayer 210 provide DRBs to support data exchange. Depending on the implementation, data exchanged on the NR PDCP sublayer 210 includes SDAP PDUs, IP packets, or Ethernet packets, for example.

In some implementations, a base station (e.g., base station 104, 106) broadcasts MBS data packets via one or more MBS radio bearers (MRB(s)), and in turn the UE 102A, 102B, or 103 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102A uses PHY sublayer 202, MAC sublayer 204, and RLC sublayer 206 to receive the MBS data packets. In some such implementations, the base station and the UE 102A, 102B, or 103 do not use a PDCP sublayer 208 and an SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102A, 102B, or 103 uses PHY sublayer 202, MAC sublayer 204, RLC sublayer 206, and PDCP sublayer 208 to receive the MBS data packets. In some such implementations, the base station and the UE 102A, 102B, or 103 do not use an SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE 102A. 102B, or 103 uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 that the UE 102A, 102B, or 103 uses to communicate with a DU (e.g., DU 174) and a CU (e.g., CU 172). The radio protocol stack 200 of FIG. 2A functionally splits as shown by the radio protocol stack 250 in FIG. 2B. In some implementations, the CU at any of the base stations 104 or 106 holds all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides DRBs to SDAP 212 and SRBs to RRC 214.

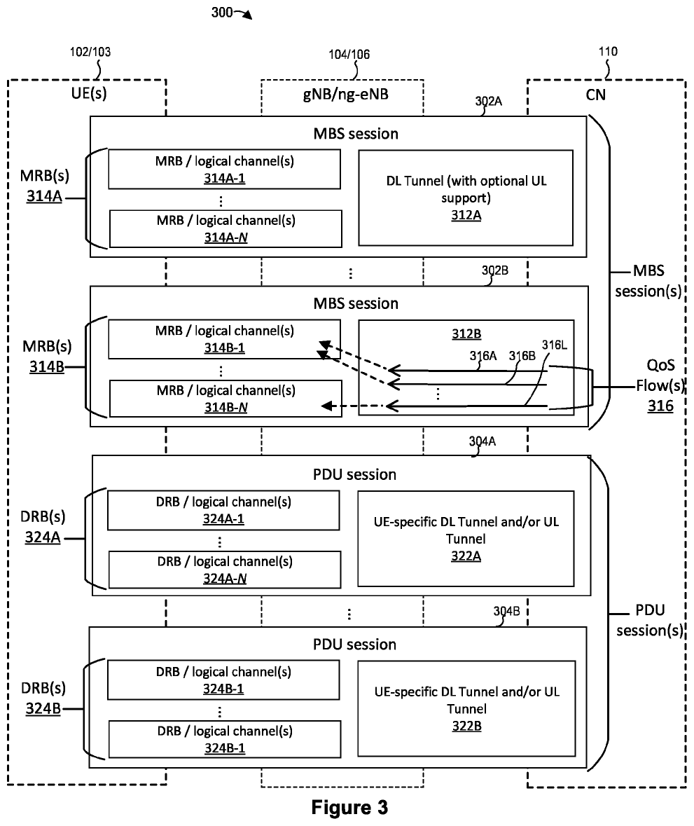

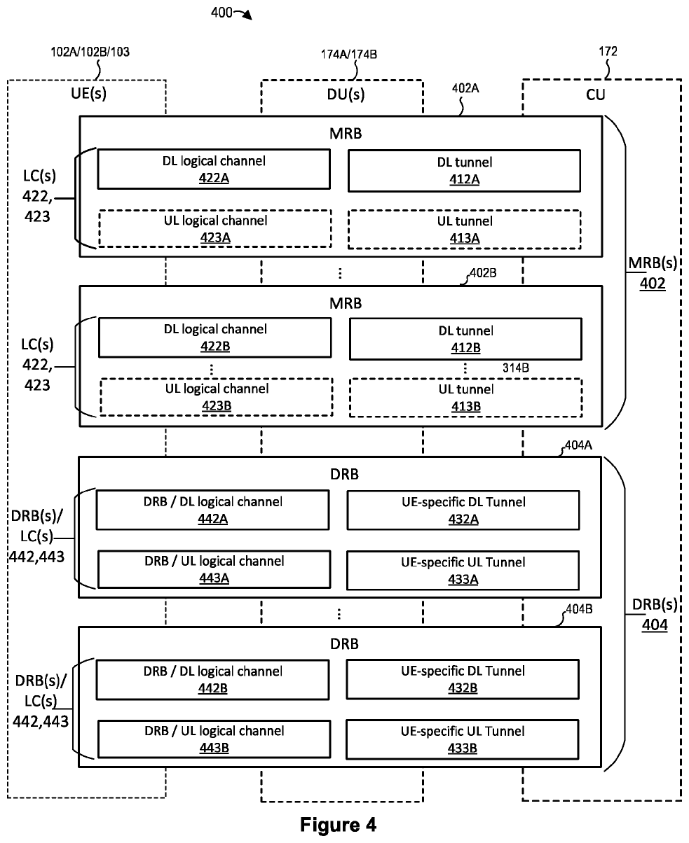

Referring to FIG. 3, in some implementations an MBS session 302A includes a tunnel 312A with endpoints at the CN 110 and the base station 104/106. The MBS session 302A corresponds to a certain session ID such as a Temporary Mobile Group Identity (TMGI), for example. The MBS data includes IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A is referred to as a downlink (DL) tunnel. In other cases, however, CN 110 and the base station 104/106 use the tunnel 312A for downlink and also for uplink (UL) MBS traffic to support, for example, commands or service requests from the UEs. Further, because the base station 104/106 can direct MBS traffic arriving via the tunnel 312A to multiple UEs, the tunnel 312A is referred to as a common tunnel or a common DL tunnel.

In some implementations, the tunnel 312A operates at the transport layer or sublayer, e.g., on the User Datagram Protocol (UDP) protocol layered over Internet Protocol (IP). As a more specific example, the tunnel 312A is associated with the General Packet Radio System (GPRS) Tunneling Protocol (GTP). In further implementations, the tunnel 312A corresponds to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. In some implementations, the CN 110 specifies the IP address and the TEID address in header(s) of a tunnel packet including an MBS data packet, and transmits the tunnel packet downstream to the base station 104/106 via the tunnel 312A (i.e., the header(s) can include the IP address and/or the TEID). For example, the header(s) can include an IP header and a GTP header including the IP address and the TEID, respectively. In such examples, then, the base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which, depending on the implementation, are configured as MBS radio bearers or MRBs, where N≥1. In some implementations, each MRB corresponds to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A, for example, corresponds to a respective MBS Traffic Channel (MTCH). In further implementations, the base station 104/106 and the CN 110 also maintain another MBS session 302B, which similarly includes a tunnel 312B corresponding to MRBs 314B-1, 314B-2, . . . 314B-N, where N≥1. In some such implementations, each of the MRBs 314B corresponds to a respective logical channel.

In some implementations, the MBS traffic includes one or multiple quality-of-service (QoS) flows, for each of the tunnels 312A, 312B, etc. For example, the MBS traffic on the tunnel 312B includes a set of flows 316 including QoS flows 316A, 316B, . . . , 316L. Further, depending on the implementation, a logical channel of an MRB supports a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 assigns different types of MBS traffic to different QoS flows. In some such implementations, a flow with a relatively high QoS value corresponds to audio packets, and a flow with a relatively low QoS value corresponds to video packets, for example. As another example, a flow with a relatively high QoS value corresponds to I-frames or complete images used in video compression, and a flow with a relatively low QoS value corresponds to P-frames or predicted pictures that include only changes to I-frames.

With continued reference to FIG. 3, in some implementations the base station 104/106 and the CN 110 maintain one or more PDU sessions to support unicast traffic between the CN 110 and particular UEs. Depending on the implementation, PDU session 304A includes a UE-specific DL tunnel and/or UE-specific UL tunnel 322A corresponding to one or more DRBs 324A, such as a DRB 324A-1, 324A-2, . . . , 324A-N. Each of the DRBs 324A can correspond to a respective logical channel, such as a Dedicated Traffic Channel (DTCH).

Now referring to FIG. 4, in some implementations, when the base station 104/106 is a distributed base station, the CU 172 and the DU 174A/174B establish tunnels for downlink data and/or uplink data associated with an MRB or a DRB. The MRB 314A-1 discussed above can be implemented as an MRB 402A connecting the CU 172 to multiple UEs such as the UE 102A and 102B, for example. In further implementations, the MRB 402A includes a DL tunnel 412A connecting the CU 172 and the DU 174A/174B, and a DL logical channel 422A corresponding to the DL tunnel 412A. In particular implementations, the DU 174A/174B maps downlink traffic received via the DL tunnel 412A to the DL logical channel 422A, which is, for example, an MTCH or a DTCH. In some implementations, the DL tunnel 412A is a common DL tunnel via which the CU 172 transmits MBS data packets to multiple UEs. In other implementations, the DL tunnel 412A is a UE-specific DL tunnel via which the CU 172 transmits MBS data packets to a particular UE.

In further implementations, the MRB 402A also includes a UL tunnel 413A connecting the CU 172 and the DU 174A/174B, and a UL logical channel 423A corresponding to the UL tunnel 413A. The UL logical channel 423A is, for example, a DTCH. In some implementations, the DU 174A/174B maps uplink traffic received via the UL logical channel 423A to the UL tunnel 413A.

Depending on the implementation, the tunnels 412A and 413A operate at the transport layer or sublayer of the F1-U interface. As a more specific example, the CU 172 and the DU 174A/174B utilize an F1-U for user-plane traffic, and the tunnels 412A and 413A are associated with the GTP-U protocol layered over UDP/IP, where IP is layered over suitable data link and physical (PHY) layers. Further, the MRB(s) 402 and/or the DRB(s) 404 in at least some cases additionally support control-plane traffic. More particularly, in some implementations, the CU 172 and the DU 174A/174B exchange F1-AP messages over an F1-C interface that relies on a Stream Control Transmission Protocol (SCTP) layered over IP, where IP is layered over suitable data link and PHY layers similar to F1-U.

Similarly, depending on the implementation, an MRB 402B includes a DL tunnel 412B and/or a UL tunnel 413B. In some implementations, the DL tunnel 412B corresponds to a DL logical channel 422B, and the UL tunnel 413B corresponds to the UL logical channel 423B.

The CU 172 in some cases uses a DRB 404A to transmit MBS data packets or unicast data packets associated with a PDU session, to a particular UE (e.g., the UE 102A or the UE 102B). In some implementations, the DRB 404A includes a UE-specific DL tunnel 432A connecting the CU 172 and the DU 174A/174B, and a DL logical channel 442A corresponding to the DL tunnel 432A. In particular implementations, the DU 174A/174B maps downlink traffic received via the DL tunnel 432A to the DL logical channel 442A, which can be a DTCH, for example. The DRB 404A further includes a UE-specific UL tunnel 433A connecting the CU 172 and the DU 174A/174B, and a UL logical channel 443A corresponding to the UL tunnel 433A. The UL logical channel 443A can be a PUSCH, for example. In some implementations, the DU 174A/174B maps uplink traffic received via the UL logical channel 443A to the UL tunnel 433A.

Similarly, depending on the implementation, a DRB 404B includes a UE-specific DL tunnel 432B, corresponding to a DL logical channel 442B, and a UE-specific UL tunnel 433B, corresponding to a UL logical channel 443B.

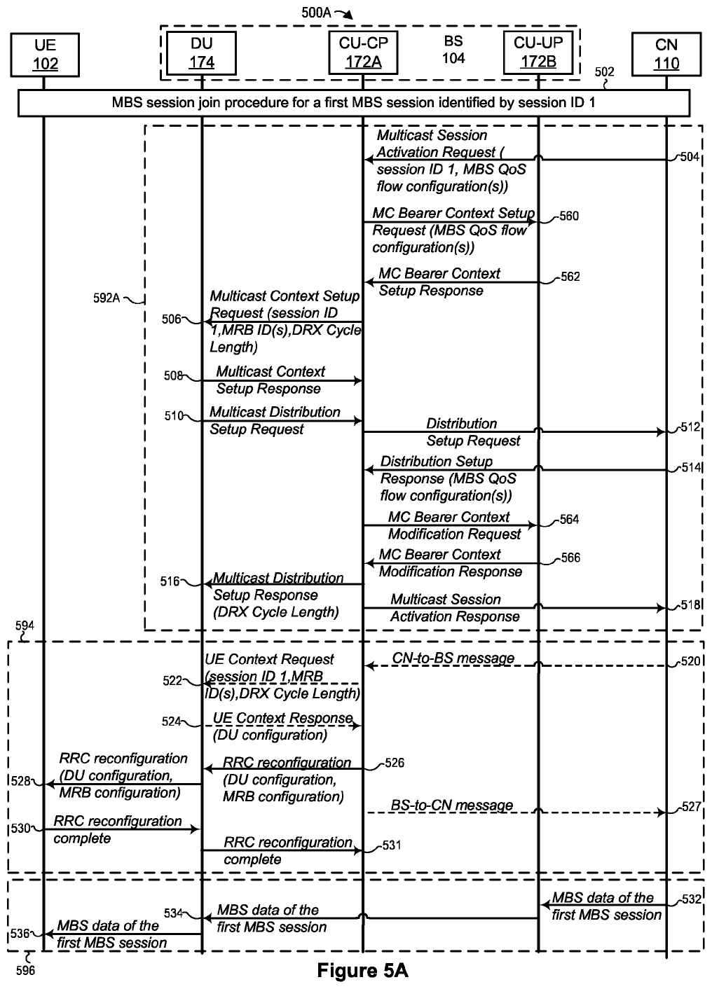

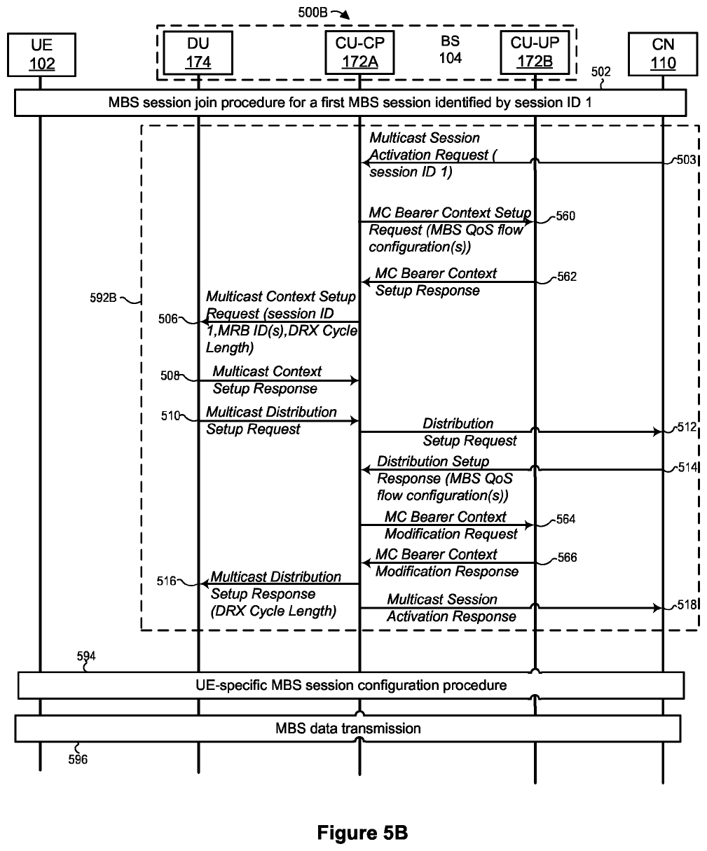

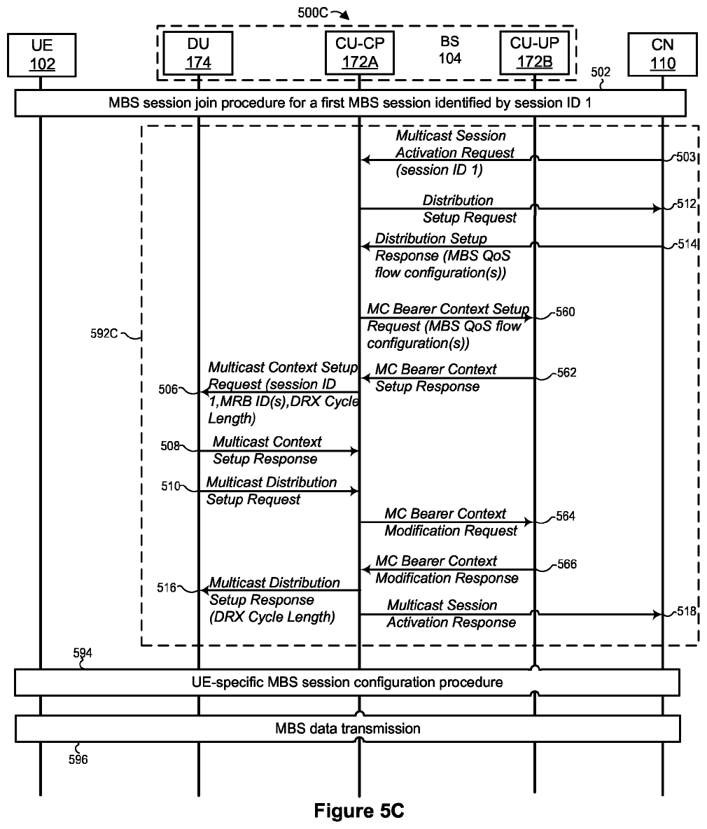

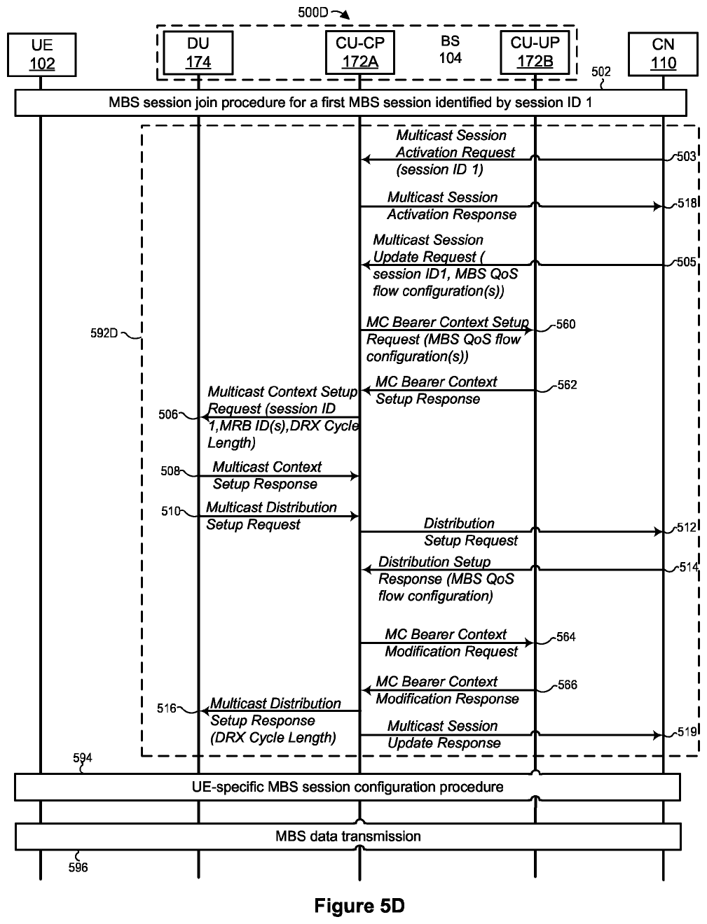

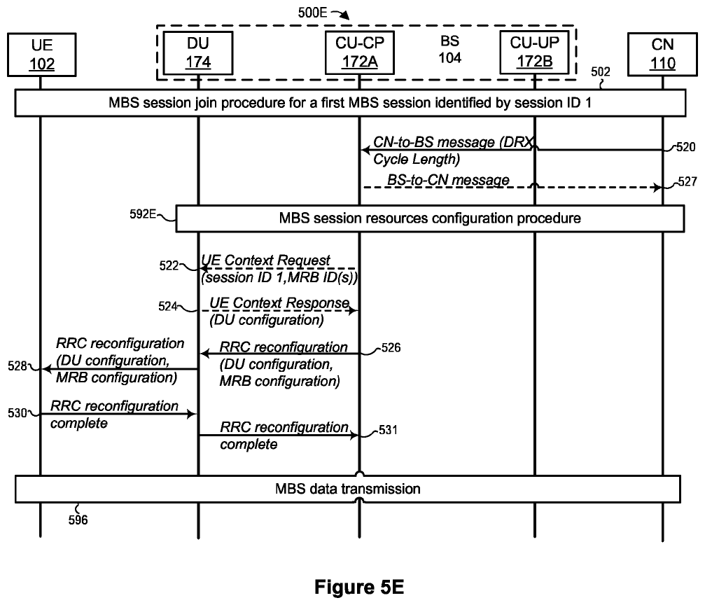

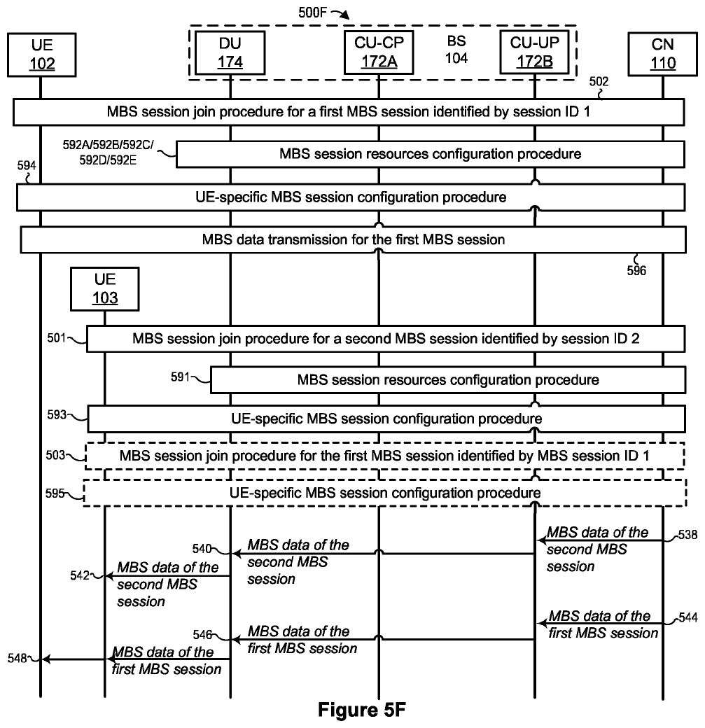

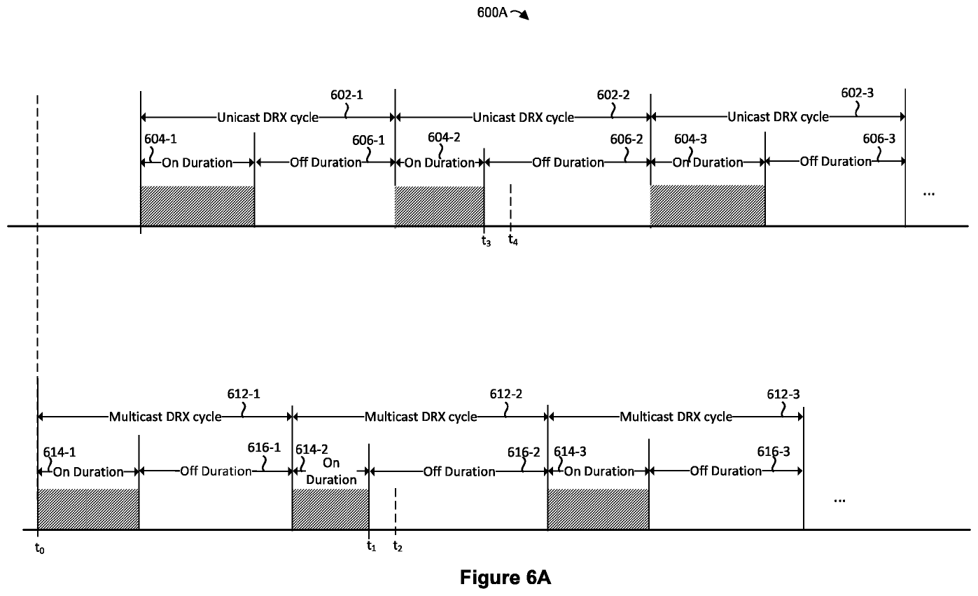

Next, FIG. 5A illustrates an example scenario 500A of establishing an MBS session. The base station 104 includes a DU 174, CU-CP 172A and CU-UP 172B. Note, the scenario 500A can also apply to an integrated CU, which is not split into CP and UP function nodes.

The UE 102 (e.g., UE 102A of FIG. 1A) initially performs 502 an MBS session join procedure with the CN 110 via the base station 104 to join a first MBS session. In some implementations, the MBS session join procedure does not involve the CU-CP 172A. In some scenarios, the UE 102 subsequently performs an additional one or more MBS join procedures, and event 502 accordingly is a first one of multiple MBS join procedures. Because the base station 104 configures a common DL tunnel for MBS traffic (rather than a UE-specific tunnel as discussed below), procedures 502 and 592A described below can occur in either order. In other words, the base station 104 can configure a common DL tunnel before even a single UE joins the first MBS session.

To perform the MBS session join procedure, the UE 102 in some implementations sends an MBS session join request message to the CN 110 via the base station 104. In response, the CN 110 sends an MBS session join response message to the UE 102 via the base station 104 to grant the UE 102 access to the first MBS session. In some implementations, the UE 102 includes a first MBS session ID (e.g., session ID 1) for the first MBS session in the MBS session join request message. The CN 110 in some cases includes the first MBS session ID in the MBS session join response message. In some implementations, the UE 102 sends an MBS session join complete message to the CN 110 via the base station 104 in response to the MBS session join response message.

In some implementations, the MBS session join request message, MBS session join response message, and MBS session join complete message are session initiation protocol (SIP) messages. In other implementations, the MBS session join request message, MBS session join response message, and MBS session join complete message are NAS messages such as 5G mobility management (5GMM) messages or 5G session management messages (5GSM). In the case of the 5GSM messages, the UE 102 transmits, to the CN 110 via the base station 104, a (first) UL container message including the MBS session join request message; the CN 110 transmits, to the UE 102 via the base station 104, a DL container message including the MBS session join response message; and the UE 102 transmits, to the CN 110 via the base station 104, a (second) UL container message including the MBS session join complete message. These container messages, depending on the implementation, are 5GMM messages. In some implementations, the MBS session join request message, MBS session join response message, and MBS session join complete message are a PDU Session Modification Request message, a PDU Session Modification Command message, and a PDU Session Modification Complete message, respectively. To simplify the following description, the terms MBS session join request message, MBS session join response message, and/or MBS session join complete message can represent either the respective container messages, or the respective messages without containers.

In some implementations, the UE 102 performs a PDU session establishment procedure with the CN 110 via the base station 104 to establish a PDU session in order to perform the (first) MBS session join procedure. During the PDU session establishment procedure, the UE 102 can communicate a PDU session ID of the PDU session with the CN 110 via the base station 104.

In some implementations, before, during, or after the first MBS session join procedure (event 502), the CN 110 sends 504 a first CN-to-BS message (e.g., Multicast Session Activation Request message) including the first MBS session ID to the CU-CP 172A to request the CU-CP 172A to configure or activate resources for the first MBS session (i.e., a multicast (MBS) session).

In some implementations, the CN 110 includes first MBS quality of service (QoS) flow configuration(s) for the first MBS session in the first CN-to-BS message. In further implementations, the first MBS QoS flow configuration(s) configures MBS QoS flow(s) 1, . . . , M associated with the first MBS session. M is an integer and larger than zero. In some implementations, the first MBS QoS flow configuration(s) include MBS QoS flow identifier(s) 1, . . . , M and/or MBS QoS flow level QoS parameter(s) 1, . . . , M for the MBS QoS flow(s) 1, . . . , M associated with the first MBS session, respectively. In further implementations, each of the MBS QoS flow configuration(s) 1, . . . , M includes an MBS QoS flow identifier and MBS QoS flow level QoS parameters for a particular MBS QoS flow.

In some implementations, the CN 110 includes, in the first CN-to-BS message, first slice information indicating a network slice used for the first MBS session. For example, the first slice information can be Single Network Slice Selection Assistance Information (S-NSSAI) identifying the particular network slice. In other implementations, the CN 110 does not include slice information (e.g., S-NSSAI) in the first CN-to-BS message. In some such cases, the first MBS session uses a default network slice.

In some implementations, the CN 110 includes, in the first CN-to-BS message, first MBS area information (e.g., MBS Service Area IE) configuring or indicating MBS area(s) for the first MBS session. In cases where the first MBS session is a location dependent multicast session, the first MBS area information includes a list of tuple {MBS Area Session ID IE, MBS Service Area Information IE}. In cases where the first MBS session is a location independent multicast session, the first MBS area information includes an MBS Service Area Information IE. An MBS Service Area Information IE in the first MBS area information includes a list of cell identity/identities and/or a list of tracking area identity/identities (TAI(s)). In some implementations, the cell identity/identities is/are cell global identity/identities (CGI(s)). In other implementations, the CN 110 does not include MBS area information (e.g., MBS Service Area IE) in the first CN-to-BS message.

After receiving 504 the first CN-to-BS message, the CU-CP 172A sends 560, to the CU-UP 172B, a first CP-to-UP message (e.g., MC Bearer Context Setup Request message) to request resources for the first MBS session. In some implementations, the CU-CP 172A determines to configure one or more MRBs for the first MBS session or the MBS QoS flow(s) 1, . . . , M. In response to the determination, the CU-CP 172A generates an MRB setup configuration for requesting resources for the one or more MRBs. The CU-CP 172A includes the first MBS session ID, the MRB setup configuration, and/or second MBS QoS flow configuration(s) for the first MBS session in the first CP-to-UP message. In some implementations, the CU-CP 172A generates the second MBS QoS flow configuration(s) based on the first MBS QoS flow configuration(s). For example, the second MBS QoS flow configuration(s) are the same as the first MBS QoS flow configuration(s). In another example, the second MBS QoS flow configuration(s) are similar to the first MBS QoS flow configuration(s). In further implementations, the second MBS QoS flow configuration(s) include QoS parameters for the MBS QoS flow(s) associated with the first MBS session. In some implementations, the QoS parameters include 5G QoS identifier(s) (5QI(s)), priority level(s), packet delay budget(s), packet error rate(s), averaging window(s), and/or maximum data burst volume(s), for example.

In some implementations, the CU-CP 172A includes the second MBS QoS flow configuration(s) (e.g., MBS QoS flows Information to be Setup and/or MRB QoS TE(s), or QoS-Flow-QoS-Parameter-List and/or QoSFlowLevelQoSParameters IE(s)) in the MRB setup configuration (e.g., MCMRBSetupConfiguration IE). In some implementations, the MRB setup configuration includes one or more MRB setup configuration item(s) (e.g. MCMRBSetupConfiguration-Item IE(s)). In some implementations, each of the MRB setup configuration item(s) includes a MRB ID, MRB configuration parameters (e.g., a PDCP configuration and/or an SDAP configuration), and/or particular one(s) of the second MBS QoS flow configuration(s) for a particular MRB. In some implementations, the PDCP configuration includes a UL PDCP sequence number size configuration, a DL PDCP sequence number size configuration, and/or an RLC mode configuration (e.g., acknowledged mode or unacknowledged mode). In some implementations, the SDAP configuration includes a default DRB configuration (e.g., DefaultDRB IE), an SDAP UL header configuration (e.g., SDAP-Header-UL), and/or an SDAP DL header configuration (e.g., SDAP-Header-DL).

In some implementations, the second MBS QoS flow configuration(s) include QoS parameters required for each of the MBS QoS flow(s) associated with the MRB(s). In some implementations, the second MBS QoS flow configuration(s) include MBS QoS flow identifier(s) 1, . . . , M and/or MBS QoS flow level QoS parameter(s) 1, . . . , M for the MBS QoS flow(s) 1, . . . , M associated with the first MBS session, respectively. The MBS QoS flow identifier(s) 1, . . . , M identify the MBS QoS flow(s) 1, . . . , M, respectively. For example, the MRB setup configuration includes MRB setup configuration item(s) 1, . . . , N for the MRB(s) 1, . . . , N, respectively. N is an integer and larger than zero. In the MRB setup configuration, the CU-CP 172A can configure mapping(s) or association(s) between the MBS QoS flow(s) 1, . . . , M and MRB(s) 1, . . . , N, where N is an integer and M>=N>0. In some implementations, the CU-CP 172A associates or maps a particular QoS flow to only a particular MRB. In other words, the CU-CP 172A refrains from associating or mapping a particular QoS flow to two MRBs. In some implementations, the MRB setup configuration item X includes MRB ID X, PDCP configuration X, SDAP configuration X, and/or particular MBS QoS flow configuration(s) of the second MBS QoS flow configuration(s), for MRB X of the MRB(s) 1, . . . , N, where 1<=X<=N.

The MCMRBSetupConfiguration is the sequence of SIZE(1 . . . maxnoofMRBs)) of MCMRBSetupConfiguration-Item. Table 1 below describes the MRB setup configuration items:

| MCMRB Setup Configuration Item | Sequence |
|---|---|
| mrb-ID | MRB-ID |
| sdap-config | SDAP-Configuration |
| mbs-pdcp-config | PDCP-Configuration |
| qoS-Flow-QoS-Parameter-List | QoS-Flow-QoS-Parameter-List |
| qoSFlowLevelQoSParameters | QoSFlowLevelQoSParameters |
| (Optional) | |
| iE-Extensions (Optional) | ProtocolExtensionContainer |
| | {{MCMRBSetupConfiguration-Item- |
| | ExtIEs}} |

Table 2 below describes another MRB setup configuration, where the CU-CP 172 A omits the SDAP-Configuration:

| MCMRB Setup Configuration Item | Sequence |
|---|---|
| mrb-ID | MRB-ID |
| mbs-pdcp-config | PDCP-Configuration |
| qoS-Flow-QoS-Parameter-List | QoS-Flow-QoS-Parameter-List |
| qoSFlowLevelQoSParameters | QoSFlowLevelQoSParameters |
| (Optional) | |
| iE-Extensions (Optional) | ProtocolExtensionContainer |
| | {{MCMRBSetupConfiguration-Item- |
| | ExtIEs}} |

In some cases where the CU-CP 172A receives the first slice information from the CN 110, e.g., in the first CN-to-BS message, the CU-CP 172A includes the first slice information in the first CP-to-UP message to indicate that the first MBS session uses the particular network slice indicated by the first slice information. In some cases where the CU-CP 172A does not receive slice information from the CN 110 (e.g., in the first CN-to-BS message), the CU-CP 172A includes preconfigured slice information in the first CP-to-UP message to indicate a particular network slice is used for the first MBS session. Alternatively, the CU-CP 172A in some such cases omits slice information from the first CP-to-UP message to indicate the first MBS session uses a default network slice.

In some cases where the CU-CP 172A receives the first MBS area information from the CN 110 (e.g., in the first CN-to-BS message), the CU-CP 172A includes the first MBS area information in the first CP-to-UP message. In some cases where the CU-CP 172A does not receive MBS area information from the CN 110, e.g., in the first CN-to-BS message, the CU-CP 172A includes preconfigured MBS area information in the first CP-to-UP message. Alternatively, the CU-CP 172A in some such cases omits MBS area information from the first CP-to-UP message. In some cases where the CU-CP 172A receives the first MBS area information from the CN 110, e.g., in the first CN-to-BS message, the CU-CP 172A retrieves an MBS Area Session ID from the first MBS area information and includes the MBS Area Session ID in the first CP-to-UP message. In some further such cases, the CU-CP 172A refrains from including an MBS Service Area Information TE in the first CP-to-UP message. In some cases where the CU-CP 172A does not receive MBS area information from the CN 110, e.g., in the first CN-to-BS message, the CU-CP 172A includes preconfigured MBS Area Session ID in the first CP-to-UP message. Alternatively, the CU-CP 172A in some such cases omits MBS Area Session ID from the first CP-to-UP message.

In response to the first CP-to-UP message, the CU-UP 172B establishes or configures resources for the MRB(s) and sends 562 a first UP-to-CP message (e.g., MC Bearer Context Setup Response message). In some implementations, the CU-UP 172B configures resources for each of the MRB(s) based on the corresponding MRB configuration parameters and/or particular one(s) of the second MBS QoS flow configuration(s). In some implementations, the CU-CP 172A configures resources for the MRB(s), MBS QoS flow(s) and/or first MBS session based on the first slice information. In some implementations, the CU-UP 172B establishes and/or configures PDCP entity/entities 1, . . . , N in accordance with the PDCP configuration(s) 1, . . . , N for the MRB(s) or MRB ID(s) 1, . . . , N, respectively. In other implementations, for each of the PDCP configuration(s) 1, . . . , N, the CU-UP 172B ignores or discards a portion of the PDCP configuration and establishes and/or configures a PDCP entity in accordance with the rest of the PDCP configuration. In one implementation, the CU-UP 172B ignores or discards the UL PDCP sequence number size configuration, and establishes and/or configures a PDCP entity in accordance with the DL PDCP sequence number size configuration and/or RLC mode. In another implementation, the CU-UP 172B ignores or discards the UL PDCP sequence number size configuration and the RLC mode, and establishes and/or configures a PDCP entity in accordance with the DL PDCP sequence number size configuration.

In some implementations, the CU-UP 172B establishes and/or configures SDAP entity/entities 1, . . . , N in accordance with the SDAP configuration(s) 1, . . . , N for the MRB(s) or MRB ID(s) 1, . . . , N, respectively. In other implementations, for each of SDAP configuration(s) 1, . . . , N, the CU-UP 172B ignores or discards a portion of the SDAP configuration and establishes and/or configures an SDAP entity in accordance with the rest of the SDAP configuration. In one implementation, the CU-UP 172B ignores or discards the default DRB configuration and SDAP UL header configuration, and establishes and/or configures a SDAP entity in accordance with the SDAP DL header configuration. In another implementation, the CU-UP 172B ignores or discards the default DRB configuration and establishes and/or configures a SDAP entity in accordance with the SDAP UL header configuration and SDAP DL header configuration. In yet other implementations, the CU-UP 172B ignores or discards the entire SDAP configuration, because the CU-UP 172B determines not to use SDAP to transmit MBS data of the first MBS session.

In some implementations, the CU-UP 172B includes, in the first UP-to-CP message, a first CU transport layer configuration to configure a common CN-to-BS DL tunnel for the first MBS session. In some implementations, the first CU transport layer configuration includes a CU transport layer address (e.g., an IP address and/or a TEID) to identify a first common CN-to-BS DL tunnel. In other implementations, the first CU transport layer configuration is an MC Bearer Context NG-U TNL Info at NG-RAN IE. In some implementations, the CU-CP 172A includes a first CU-CP MBS E1AP ID in the first CP-to-UP message to identify the first MBS session on an E1 interface between the CU-CP 172A and CU-UP 172B. In some implementations, the CU-UP 172B includes a first CU-UP MBS E1AP ID in the first UP-to-CP message to identify the first MBS session on an E1 interface between the CU-CP 172A and CU-UP 172B. In further implementations, the CU-UP 172B includes the first CU-CP MBS E1AP ID in the first UP-to-CP message.

The events 560 and 562 are collectively referred to in FIG. 5A as an MC Bearer Context Setup procedure.

After (e.g., in response to) receiving 504 the first CN-to-BS message, the CU-CP 172A sends 506 a first CU-to-DU message (e.g., a Multicast Context Setup Request message) to the DU 174 to request a set-up for a multicast context and/or a common DL tunnel for the first MBS session. See FIG. 4 and accompanying text. The CU-CP 172A determines to configure one or more MRBs for the first MBS session or the MBS QoS flow(s) 1, . . . , M. In response to the determination, the CU-CP 172A generates an MRB to perform a setup configuration for requesting resources for the one or more MRBs. In some implementations, the first CU-to-DU message includes information related to configuring a DRX for the UE 102 participating in the MBS session, such as the first MBS session ID, the MRB to perform a setup configuration, and/or third MBS QoS flow configuration(s) for the first MBS session. In further implementations, the information related to configuring the DRX in the first CU-to-DU message includes DRX-specific information, such as a DRX cycle length, an on-duration period length, etc.

In some implementations, the CU-CP 172A includes the first slice information in the first CU-to-DU message to indicate that the first MBS session uses the particular network slice indicated by the first slice information. In some implementations, the MRB to perform a setup configuration includes MRB ID(s), each identifying a MRB, and the DU 174 configures resources (e.g., PHY, MAC and/or RLC resources) for the MRB(s). In some implementations, the MRB ID(s) included in the first CU-to-DU message is/are the same as the MRB ID(s) included in the first CP-to-UP message. In some implementations, the CU-CP 172A generates the third MBS QoS flow configuration(s) based on the first MBS QoS flow configuration(s). For example, the third MBS QoS flow configuration(s) are the same as the first MBS QoS flow configuration(s). In another example, the third MBS QoS flow configuration(s) are similar to the first MBS QoS flow configuration(s). In some implementations, the CU-CP 172A includes a CU MBS F1AP ID in the first CU-to-DU message to identify the first MBS session on an F1 interface between the CU-CP 172A and DU 174.

In cases where the CU-CP 172A receives the first slice information (e.g., S-NSSAI) associated with the first MBS session from the CN 110, e.g., in the first CN-to-BS message, the CU-CP 172A includes the first slice information in the first CU-to-DU message to indicate the particular network slice is used for the first MBS session, similar to the first CP-to-UP message described above. As such, similar embodiments apply to the first CU-to-DU message.

In some cases where the CU-CP 172A receives the first MBS area information from the CN 110, e.g., in the first CN-to-BS message, the CU-CP 172A includes the first MBS area information in the first CU-to-DU message, similar to the first CP-to-UP message described above. As such, similar embodiments apply to the first CU-to-DU message.

In response to receiving 506 the first CU-to-DU message, the DU 174 establishes or configures resources (e.g., a multicast context and/or PHY, MAC, RLC and/or tunnel resources) for the MRB(s) and sends 508 a first DU-to-CU message (e.g., a Multicast Context Setup Response message) to the CU-CP 172A. In some implementations, the DU 174 establishes and/or configures a MAC entity for the MRB(s). In some implementations, the DU 174 establishes and/or configures RLC entity/entities 1, . . . , N for the MRB(s) or MRB ID(s) 1, . . . , N, respectively. In some implementations, the DU 174 includes, in the first DU-to-CU message, a first DU transport layer configuration to configure a common CU-to-DU DL tunnel for the first MBS session (e.g., for an MRB identified by one of the MRB ID(s)). In further implementations, the DU 174 includes, in the first DU-to-CU message, additional DU transport layer configuration(s) to configure additional common CU-to-DU DL tunnel(s) for additional MRB(s) identified by additional MRB ID(s) of the MRB IDs. In some implementations, the DU 174 includes, in the first DU-to-CU message, the MRB ID(s) associated with the first DU transport layer configuration and/or the additional DU transport layer configuration(s). For example, each of the MRB ID(s) is associated with a particular DU transport layer configuration. In some implementations, each of the first DU transport layer configuration and/or the additional DU transport layer configuration(s) includes a DU transport layer address (e.g., an IP address and/or a TEID). In some implementations, each of the first DU transport layer configuration and/or the additional DU transport layer configuration(s) is a MRB F1-U TNL Info at DU IE.

The events 506 and 508 are collectively referred to in FIG. 5A as a Multicast Context Setup procedure. In some implementations, the Multicast Context Setup procedure and the MC Bearer Context Setup procedure occur in parallel. In other implementations, the Multicast Context Setup procedure occurs after the MC Bearer Context Setup procedure, or vice versa.

In some implementations, the DU 174 transmits 510 a second DU-to-CU message (e.g., Multicast Distribution Setup Request message) to the CU-CP 172A after receiving 506 the first CU-to-DU message or transmitting 508 the first DU-to-CU message. In some implementations, the DU 174 includes the first DU transport layer configuration and/or the additional DL transport layer configuration(s) in the second DU-to-CU message instead of the first DU-to-CU message. In some implementations, the DU 174 includes, in the second DU-to-CU message, the MRB ID(s) associated with the first DU transport layer configuration and/or the additional DU transport layer configuration(s) instead of the first DU-to-CU message. Thus, in further implementations, the first DU-to-CU message does not include a DU transport layer configuration. In some implementations, the CU-CP 172A transmits 516 a second CU-to-DU message (e.g., Multicast Distribution Setup Response message) to the DU 174 in response to the second DU-to-CU message. In some implementations, the second CU-to-DU message is similar to the first CU-to-DU message the CU 172 transmits in event 506. The events 510 and 516 are collectively referred to in FIG. 5A as a Multicast Distribution Setup procedure.

After receiving 504 the first CN-to-BS message, receiving 562 the first UP-to-CP message, receiving 508 the first DU-to-CU message, or receiving 510 the second DU-to-CU message, the CU-CP 172A transmits 512 a first BS-to-CN message (e.g., a Distribution Setup Request message) to the CN 110. In some implementations, the CU-CP 172A transmits 512 the first BS-to-CN message to the CN 110 before receiving 508 the first DU-to-CU message or receiving 510 the second DU-to-CU message. In some implementations, the CU-CP 172A includes the first CU transport layer configuration in the first BS-to-CN message. Thus, in some such implementations, the CN 110 sends MBS data to the CU-UP 172B via the first common CN-to-BS DL tunnel as described for event 532 below. In some implementations, the CU-CP 172A includes the first MBS session ID in the first BS-to-CN message. In some implementations, the CN 110 sends 514 a second CN-to-BS message (e.g., a Distribution Setup Response message) to the CU-CP 172A in response to the first BS-to-CN message. In some implementations, the CN 110 can include a first CN transport layer configuration in the second CN-to-BS message. The first CN transport layer configuration includes at least one CN transport layer address (e.g., IP address(s)) to identify the first common CN-to-BS DL tunnel. In some implementations, the at least one transport layer address includes an IP source address and/or an IP multicast address. In some implementations, the first CN transport layer configuration includes a TEID at/of the CN 110. In some implementations, the CN 110 includes fourth MBS QoS flow configuration(s) for the first MBS session in the second CN-to-BS message. In some implementations, the fourth MBS QoS flow configuration(s) are similar to the first MBS QoS flow configuration(s).

After receiving 514 the second CN-to-BS message, the CU-CP 172A sends 564 a second CP-to-UP message (e.g., MC Bearer Context Modification Request message) to the CU-UP 172B. In some implementations, the CU-CP 172A includes the MRB ID(s), first DU transport layer configuration, additional DU transport layer configuration(s), and/or first CN transport layer configuration in the second CP-to-UP message. In response to receiving the second CP-to-UP message of event 564, the CU-UP 172B sends 566 a second UP-to-CP message (e.g., MC Bearer Context Modification Response message). In some implementations, the CU-UP 172B includes the MRB ID(s) and/or a second CU transport layer configuration in the second UP-to-CP message. In some implementations, the second CU transport layer configuration includes a CU transport layer address (e.g., an IP address) to identify the first common DU-to-CU UL tunnel. The second CU transport layer configuration can additionally include a TEID at/of the CU-UP 172B. In some implementations, the second CU transport layer configuration is the same as the first CU transport layer configuration. In other implementations, the second CU transport layer configuration is different from the first CU transport layer configuration. In some implementations, the CU-CP 172A includes the second CU transport layer configuration in the second CU-to-DU message and sends 516 the second CU-to-DU message to the DU 174 in response to the second DU-to-CU message of event 510. After receiving 566 the second UP-to-CP message or transmitting 516 the second CU-to-DU message, the CU-CP 172A sends 518 a second BS-to-CN message (e.g. Multicast Session Activation Response message) to the CN 110 in response to the first CN-to-BS message. Alternatively, the CU-CP 172A sends 518 the second BS-to-CN message to the CN 110 before receiving 566 the second UP-to-CP message or transmitting 516 the second CU-to-DU message. For example, the CU-CP 172A sends 518 the second BS-to-CN message to the CN 110 after receiving 504 the first CN-to-BS message, receiving 562 the first UP-to-CP message, receiving 510 the second DU-to-CU message, or receiving 514 the second CN-to-BS message.

In some implementations, the CU-CP 172A includes the fourth MBS QoS flow configuration(s) in the MC Bearer Context Modification Request message. In some such implementations, the CU-UP 172B modifies or reconfigures resources for the MRB(s) based on the fourth MBS QoS flow configuration(s). In some implementations, the CU-UP 172B determines whether to modify or reconfigure resources for the MRB(s) based on the fourth MBS QoS flow configuration(s). For example, if the resources for the MRB(s) at event 562 still can fulfill the fourth MBS QoS flow configuration(s), the CU-UP 172B does not modify or reconfigure resources for the first MRB. Otherwise, the CU-UP 172B modifies or reconfigures resources for the MRB(s) based on the fourth MBS QoS flow configuration(s). In some implementations, the CU-UP 172B determines whether to modify or reconfigure resources for a particular MRB of the MRB(s) based on the fourth MBS QoS flow configuration(s).

The events 504, 560, 562, 506, 508, 510, 512, 514, 564, 566, 516, and 518 are collectively referred to in FIG. 5A as an MBS session resource setup procedure 592A. The messages in the procedure 592A can be MBS session associated messages, i.e., messages associated to the first session instead of a particular UE (e.g., the UE 102A).

In some implementations, the CU-CP 172A includes a multicast DRX cycle request in the first CU-to-DU message of event 506 to request the DU 174 to configure a multicast DRX cycle for the first MBS session. In some implementations, the first multicast DRX cycle request includes information related to configuring DRX, such as a desired multicast DRX cycle length. In some implementations the first multicast DRX cycle request is an IE (e.g., DRX Cycle IE or multicast DRX Cycle IE) of the first CU-to-DU message. In other implementations, the CU-CP 172A sends (not shown) an additional CU-to-DU message (e.g., a Multicast Context Modification Request message) including the multicast DRX cycle request to the DU 174. In response, the DU 174 sends (not shown) an additional DU-to-CU message to the CU-CP 172A. In some implementations, the CU-CP 172A additionally or alternatively includes the multicast DRX cycle request in the second CU-to-DU message of event 516 as described above.

In some implementations, the CN 110 sends 520 to the CU-CP 172A a third CN-to-BS message indicating (only) that the UE 102 (e.g., the UE 102A) joins the first MBS session. In some implementations, the CN 110 can include, in the third CN-to-BS message, the first MBS session ID and/or MBS QoS flow identifier(s) identifying the first MBS session and MBS QoS flow(s) associated with the first MBS session, respectively. In response to the third CN-to-BS message, the CU-CP 172A can send 527 a third BS-to-CN message to the CN 110. After (e.g., in response to) receiving the third CN-to-BS message, the CU-CP 172A can send 522 to the DU 174 a UE Context Request message for the UE 102 (e.g., the UE 102A). In some implementations, the CU-CP 172A can include the information related to configuring DRX for the UE 102, such as a DRX cycle length and/or MRB ID(s) in the UE Context Request message, as described above. In some implementations, the CU-CP 172A determines the MRB ID(s) based on the first MBS session ID and/or MBS QoS flow identifier(s) received in the third CN-to-BS message. In some implementations, the CU-CP 172A does not include the first MBS session ID in the UE Context Request message.

In response to the UE Context Request message of event 522, the DU 174 sends 524 to the CU-CP 172A a UE Context Response message including configuration parameters for the UE 102A to receive MBS data of the first MBS session via the MRB(s). Some or all of the configuration parameters may be associated with the MRB(s) and/or MRB ID(s). In some implementations, the DU 174 generates a DU configuration (i.e., a first DU configuration) to include the configuration parameters (i.e., first plural configuration parameters) and includes the DU configuration in the UE Context Response message. In some implementations, the DU configuration can be a CellGroupConfig IE. In other implementations, the DU configuration can be an MBS-specific IE. In some implementations, the configuration parameters configure one or more logical channels (LCs) for the MRB(s). For example, the configuration parameters include one or more logical channel IDs (LCIDs) to configure the one or more logical channel. Each of the LCIDs identifies a particular logical channel of the one or more logical channels.

In some implementations, the third CN-to-BS message and the third BS-to-CN message are a PDU Session Resource Modify Request message and a PDU Session Resource Modify Response message, respectively. In other implementations, the third CN-to-BS message and the third BS-to-CN message are a PDU Session Resource Setup Request message and a PDU Session Resource Setup Response message, respectively. In some implementations, the third CN-to-BS message and the third BS-to-CN message are UE-associated messages, i.e., the messages are associated with a particular UE (e.g., the UE 102A, 102B, or 103).

In some implementations, the UE Context Request message and the UE Context Response message are a UE Context Setup Request message and a UE Context Setup Response message, respectively. In some alternative implementations, the UE Context Request message and the UE Context Response message are a UE Context Setup Request message and a UE Context Modification Required message, respectively. In some such implementations, the DU 174 sends a UE Context Setup Response message to the CU-CP 172A in response to the UE Context Setup Request message, and the CU-CP 172A sends a UE Context Modification Confirm message to the DU 174 in response to the UE Context Modification Required message. In other implementations, the UE Context Request message and the UE Context Response message are a UE Context Modification Request message and a UE Context Modification Response message, respectively. In some alternative implementations, the UE Context Request message and the UE Context Response message are a UE Context Modification Request message and a UE Context Modification Required message, respectively. In some such implementations, the DU 174 sends a UE Context Modification Response message to the CU-CP 172A in response to the UE Context Modification Request message, and the CU-CP 172A sends a UE Context Modification Confirm message to the DU 174 in response to the UE Context Modification Required message.

In some implementations, the CU-CP 172A can perform a (UE-specific) Bearer Context procedure with the CU-UP 172B for the UE 102 (e.g., the UE 102A) after (e.g., in response to) receiving the third CN-to-BS message. In the Bearer Context procedure, the CU-CP 172A sends a Bearer Context Request message to the CU-UP 172B to request establishing or modifying a (unicast) bearer context for the UE 102. In response, the CU-UP 172B establishes or modifies a (unicast) bearer context for the UE 102 and sends a Bearer Context Response message to the CU-CP 172A. In other implementations, the CU-CP 172A refrains from performing a (UE-specific) Bearer Context procedure for the UE 102 with the CU-UP 172B upon receiving the third CN-to-BS message. In some implementations, the Bearer Context procedure is a Bearer Context Setup procedure defined in section 8.3.1 in 3GPP specification 37.483 or 38.463. In such cases, the Bearer Context Request message and Bearer Context Setup message are Bearer Context Setup Request message and Bearer Context Setup Response message, respectively. In other implementations, the Bearer Context procedure is a Bearer Context Modification procedure defined in section 8.3.2 in 3GPP specification 37.483 or 38.463. In such cases, the Bearer Context Request message and Bearer Context Setup message are Bearer Context Modification Request message and Bearer Context Modification Response message, respectively.

After receiving 524 the UE Context Response message or performing 502 an MBS session join procedure with the CN 110 and the UE 102, the CU-CP 172A generates an RRC reconfiguration message (e.g., RRCReconfiguration message) including the configuration parameters and one or more MRB configurations (i.e., first MRB configuration(s)) and transmits 526 the RRC reconfiguration message to the DU 174. In turn, the DU 174 transmits 528 the RRC reconfiguration message to the UE 102 (e.g., the UE 102A). The UE 102 then transmits 530 an RRC reconfiguration complete message to the DU 174, which in turn transmits 531 the RRC reconfiguration complete message (e.g., RR CReconfigurationComplete message) to the CU-CP 172A.

The events 520, 522, 524, 526, 527 (discussed below), 528, 530, and 531 are collectively referred to in FIG. 5A as a UE-specific MBS session configuration procedure 594. The CN 110 and/or CU-CP 172A perform the procedure 594 for each of UEs (e.g., the UE 102A and the UE 102B) joining the first MBS session. Depending on the implementation, the procedure 594 occurs before, after, or overlapping with the procedure 592A.

In some implementations, the DU 174, after transmitting 524 the UE Context Response message, transmits (not shown) a third DU-to-CU message including a portion of the configuration parameters for the UE 102 to the CU-CP 172A, instead of including all of the configuration parameters in the UE Context Response message of event 524. Depending on the implementation, the portion of the configuration parameters includes configuration(s) as described herein. In such cases, the CU-CP 172A transmits a second RRC reconfiguration message including the portion of the configuration parameters to the UE 102 via the DU 174 after transmitting 526 the RRC reconfiguration message or receiving 531 the RRC reconfiguration complete message, similar to the events 526, 528. In response, the UE 102 transmits a second RRC reconfiguration complete message to the CU-CP 172A via the DU 174, similar to the events 530, 531. Depending on the implementation, the third DU-to-CU message is a UE Context Modification Required message or a UE Context Modification Response message. In some implementations, the CU-CP 172A sends a third CU-to-DU message to the DU 174 to trigger transmission of the third DU-to-CU message, similar to the UE Context Request message of event 522.

In some implementations, the CU-CP 172A generates a PDCP PDU including the RRC reconfiguration message and sends 526 a CU-to-DU message including the PDCP PDU to the DU 174. In such implementations, the DU 174 retrieves the PDCP PDU from the CU-to-DU message and transmits 528 the PDCP PDU to the UE 102 via the RLC layer 206B, MAC layer 204B, and/or PHY layer 202B. The UE 102 receives 528 the PDCP PDU from the DU 174 via the PHY layer 202B, MAC layer 204B, and/or RLC layer 206B. In some implementations, the UE 102 generates a PDCP PDU including the RRC reconfiguration complete message and transmits 530 the PDCP PDU to the DU 174 via the RLC layer 206B, MAC layer 204B, and/or PHY layer 202B. The DU 174 receives 522 the PDCP PDU from the UE 102 via the PHY layer 202B, MAC layer 204B, and/or RLC layer 206B, and sends 531 a DU-to-CU including the PDCP PDU to the CU-CP 172A. The CU-CP 172A retrieves the PDCP PDU from the DU-to-CU message and retrieves the RRC reconfiguration complete message from the PDCP PDU.

In some implementations, the CU-CP 172A transmits 527 the third BS-to-CN message to the CN 110 in response to the third CN-to-BS message 520. Depending on the implementation, the CU-CP 172A sends 527 the third BS-to-CN message to the CN 110 before or after receiving 531 the RRC reconfiguration complete message and/or receiving 524 the UE Context Response message. The CU-CP 172A can include a first CN UE interface ID and a first RAN UE interface ID in the third BS-to-CN message. In some implementations, the CN 110 assigns the first CN UE interface ID identifying the UE 102 (e.g., the UE 102A), and the CU-CP 172A assigns the first RAN UE interface ID identifying the UE 102 (e.g., the UE 102A). In some implementations, the “CN UE interface ID” is an “AMF UE NGAP ID” and the “RAN UE interface ID” is a “RAN UE NGAP ID”.

After receiving 518 the second BS-to-CN message or 527 the third BS-to-CN message, the CN 110 (e.g., (MB-)UPF 162) sends 532 MBS data (e.g., one or multiple MBS data packets) for the first MBS session to the CU-UP 172B via the first common CN-to-BS DL tunnel (i.e., in accordance with the first CU transport layer configuration and/or the first CN transport layer configuration). In some implementations, the CN 110 generates tunnel packets, each including a particular MBS data packet to transmit the MBS data packets via the first common CN-to-BS DL tunnel. In a header of each of the tunnel packets, the CN 110 sets a source IP address, a target IP address and a TEID to the IP address in the first CN transport layer configuration, the IP address in the first CU transport layer configuration, and the TEID in the first CU transport layer configuration, respectively. In such implementations, the IP address in the first CN transport layer configuration, the IP address in the first CU transport layer configuration, and the TEID in the first CU transport layer configuration identify the first common CN-to-BS DL tunnel.

When the CU-UP 172B receives 532 the MBS data of the first MBS session from the CN 110, the CU-UP 172B in turn sends 534 the MBS data to the DU 174 via the first common CU-to-DU tunnel and/or additional common CU-to-DU DL tunnel(s) (i.e., in accordance with the first and/or additional DU transport layer configuration(s)). In some cases where the MBS data is associated with some of the MBS QoS flow(s) identified by the MBS QoS flow identifier(s), the CU-UP 172B determines which common CU-to-DU DL tunnel(s) to use to send the MBS data to the DU 174, based on the one or some of MBS QoS flow identifier(s). For example, when the CU-UP 172B receives from the CN 110 a first MBS data packet associated with a first one of the MBS QoS flow identifier(s), the CU-UP 172B sends the first MBS data packet to the DU 174 via the first common CU-to-DU DL tunnel. When the CU-UP 172B receives from the CN 110 a second MBS data packet associated with a second one of the MBS QoS flow identifier(s), the CU-UP 172B sends the second MBS data packet to the DU 174 via a one of the additional common CU-to-DU tunnel(s).

In some implementations, the CU-UP 172B generates tunnel packets, each including a particular MBS data packet to transmit the MBS data packets via the first common CU-to-DU tunnel and/or additional common CU-to-DU DL tunnel, similar to the CN-to-BS tunnel described in more detail above. In cases where the CU-UP 172B transmits one of the tunnel packets via the additional common CU-to-DU tunnel, the CU-UP 172B sets parameters similar to event 532 above, using the DU and CU transport layers rather than the CU and CN transport layers.

When the DU 174 receives 534 the MBS data from the CU-UP 172B, the DU 174 transmits (e.g., multicast or unicast) 536 the MBS data via the one or more logical channels to the UE 102. See FIG. 4 and accompanying text. The UE 102 receives 536 the MBS data via the one or more logical channels. For example, the CU-UP 172B may receive 532 an MBS data packet, generate a PDCP PDU including the MBS data packet, and transmit 534 the PDCP PDU to the DU 174. In turn, the DU 174 generates a MAC PDU including the LCID and the PDCP PDU, and transmits 536 the MAC PDU to the UE 102 via multicast or unicast. The UE 102 receives 536 the MAC PDU via multicast or unicast, retrieves the PDCP PDU and the LCID from the MAC PDU, identifies the PDCP PDU associated with the MRB in accordance with the LCID, and retrieves the MBS data packet from the PDCP PDU in accordance with a PDCP configuration within the MRB configuration. In some implementations, the DU 174 transmits 536 the MBS data or the MAC PDU via one or more multicast transmissions (e.g., dynamic or SPS multicast transmission(s)) to the UE 102 as described above. In some such cases, the UE 102 receives 536 the MBS data or the MAC PDU via the one or more multicast transmissions from the DU 174 as described above.

In some implementations, the CU-CP 172A requests the DU 174 to configure a UE-specific CU-to-DU DL tunnel for the UE 102 in the UE Context Request message of event 522. In some implementations, the CU-CP 172A includes a CU transport layer configuration in the UE Context Request message to request a UE-specific CU-to-DU DL tunnel for the UE 102. The CU transport layer configuration includes a CU transport layer address (e.g., an IP address) to identify a UE-specific CU-to-DU DL tunnel. In further implementations, the CU transport layer configuration includes a TEID at/of the CU-UP 172B. In response, the DU 174 includes, in the UE Context Response message, a DU transport layer configuration configuring the UE-specific CU-to-DU DL tunnel. The DU transport layer configuration includes a DU transport layer address (e.g., an IP address and/or a TEID). Depending on the implementation, after receiving 524 the UE Context Response message, the CU-CP 172A sends a Bearer Context Modification Request message including the DU transport layer configuration to the CU-UP 172B and in response, the CU-UP 172B sends a Bearer Context Modification Response message to the CU-CP 172A. In further implementations, the CU-UP 172B later transmits 534 the MBS data to the DU 174 via the UE-specific CU-to-DU DL tunnel.

In some implementations, the configuration parameters also include one or more RLC bearer configurations, each associated with a particular MRB. Each of the MRB configuration(s) includes an MRB ID, a PDCP configuration, the first MBS session ID, a PDCP reestablishment indication (e.g., reestablishPDCP), and/or a PDCP recovery indication (e.g., recoveryPDCP). In some implementations, the PDCP configuration is a PDCP-Config IE for DRB. In some implementations, the RLC bearer configuration is an RLC-BearerConfig IE. In some implementations, the RLC bearer configuration may include a logical channel ID configuring a logical channel. In some implementations, the logical channel is a (multicast) MBS traffic channel (MTCH). In other implementations, the logical channel is a dedicated traffic channel (DTCH). In some implementations, the configuration parameters include a logical channel configuration (e.g., LogicalChannelConfig IE) configuring the logical channel. In some implementations, the RLC bearer configuration includes the MRB ID.

In some implementations, the CU-CP 172A configures the MRB as a DL-only RB in the MRB configuration. For example, the CU-CP 172A refrains from including UL configuration parameters in the PDCP configuration within the MRB configuration to configure the MRB as a DL-only RB. In some implementations, the CU-CP 172A includes only DL configuration parameters in the MRB configuration (e.g., as described above). In such cases, the CU-CP 172A configures the UE 102 to not transmit UL PDCP data PDU via the MRB to the DU 174 and/or the CU-CP 172A by excluding the UL configuration parameters for the MRB in the PDCP configuration in the MRB configuration. In another example, the DU 174 refrains from including UL configuration parameters in the RLC bearer configuration. In such cases, the DU 174 configures the UE 102 not to transmit the control PDU(s) via the logical channel to the base station 104 by excluding the UL configuration parameters from the RLC bearer configuration.

In cases where the DU 174 includes UL configuration parameter(s) in the RLC bearer configuration, the UE 102 transmits control PDU(s) (e.g., PDCP Control PDU(s) and/or RLC Control PDU(s)) via the logical channel to the DU 174 using the UL configuration parameter(s). In some implementations where the control PDU is a PDCP control PDU, the DU 174 sends the PDCP control PDU to the CU-UP 172B. For example, the CU-CP 172A configures the UE to receive MBS data with a (de)compression protocol (e.g., robust header compression (ROHC) protocol). In some such cases, when the CU-UP 172B receives 532 an MBS data packet from the CN 110, the CU-UP 172B compresses the MBS data packet with the compression protocol to obtain compressed MBS data packet(s) and transmits 534 a PDCP PDU including the compressed MBS data packet to the DU 174 via the first or additional common CU-to-DU DL tunnel. In turn, the DU 174 transmits (e.g., multicast or unicast) 536 the PDCP PDU to the UE 102 via the logical channel. When the UE 102 receives 536 the PDCP PDU via the logical channel, the UE 102 retrieves the compressed MBS data packet from the PDCP PDU. The UE 102 decompresses the compressed MBS data packet(s) with the (de)compression protocol to obtain the original MBS data packet. In some such cases, the UE 102 transmits a PDCP Control PDU including, a header compression protocol feedback (e.g., interspersed ROHC feedback) for operation of the header (de)compression protocol, via the logical channel to the DU 174. In turn, the DU 174 sends the PDCP Control PDU to the CU-UP 172B via a UL tunnel.

In some implementations, the UL tunnel is the first common DU-to-CU tunnel configured in the first DU transport layer configuration and the second CU transport layer configuration. For example, the IP address in the first DU transport layer configuration, and the IP address and TEID in the second CU transport layer configuration identify the first common DU-to-CU tunnel. In other implementations, the UL tunnel is specific for the UE 102 (e.g., the UE 102A). In some implementations, the CU-CP 172A can include, in the UE Context Request message, a CU transport layer configuration configuring the UE-specific UL tunnel. The CU transport layer configuration includes a CU transport layer address (e.g., an Internet Protocol (IP) address) and a TEID to identify the UE-specific UL tunnel. In some implementations, the DU 174 includes, in the UE Context Response message, a DU transport layer configuration configuring the UE-specific UL tunnel. The DU transport layer configuration includes a DU transport layer address (e.g., an IP address and/or a TEID). For example, the IP address in the DU transport layer configuration, and the IP address and TEID in the CU transport layer configuration identify the first common UL tunnel.

In some implementations, the MRB configuration can be an MRB-ToAddMod IE including an MRB ID (e.g., mrb-Identity or MRB-Identity). An MRB ID identifies a particular MRB of the MRB(s). In some implementations where the CU-CP 172A has configured DRB(s) to the UE 102 for unicast data communication, the CU-CP 172A sets one or more of the MRB ID(s) to values different from DRB ID(s) of the DRB(s). In some such cases, the UE 102 and the CU-CP 172A can distinguish whether an RB is an MRB or DRB in accordance with an RB ID of the RB. In other implementations, the CU-CP 172A sets one or more of the MRB ID(s) to values which can be the same as the DRB ID(s). In some such cases, the UE 102 and the CU-CP 172A can distinguish whether an RB is an MRB or DRB in accordance an RB ID of the RB and an RRC IE configuring the RB. For example, a DRB configuration configuring a DRB is a DRB-ToAddMod IE including a DRB identity (e.g., drb-Identity or DRB-Identity) and a PDCP configuration. Thus, the UE 102 can determine an RB is a DRB if the UE 102 receives a DRB-ToAddMod IE configuring the RB, and determine an RB is an MRB if the UE 102 receives an MRB-ToAddMod IE configuring the RB. Similarly, the CU-CP 172A determines an RB is a DRB if the CU-CP 172A transmits a DRB-ToAddMod IE configuring the RB to the UE 102, and determines an RB is an MRB if the CU-CP 172A transmits an MRB-ToAddMod IE configuring the RB to the UE 102.

In some implementations, the configuration parameters for receiving MBS data of the first MBS session include one or more logical channel IDs to configure one or more logical channels. In some implementations, the logical channel(s) are DTCH(s). In other implementations, the logical channel(s) are MTCH(s).

In some implementations, the configuration parameters include dynamic scheduling multicast configuration parameter(s) for the UE 102 to receive 536 multicast transmissions, each including MBS data or a particular portion of MBS data for the first MBS session. In some implementations, the dynamic scheduling multicast configuration parameter(s) include at least one of the configuration parameters as described in detail below.

In some implementations, the configuration parameters include a group radio network temporary identifier (G-RNTI), an MBS-specific RNTI. The DU 174 dynamically schedules each multicast transmission, including a particular MAC PDU, for the UE 102 by generating a DCI, scrambling a cyclic redundancy check (CRC) of the DCI with the G-RNTI, and transmitting the DCI and the scrambled CRC on a PDCCH. The MAC PDU includes an MBS data packet or a portion of an MBS data packet. The UE 102 receives the DCI and scrambled CRC on the PDCCH and verifies the scrambled CRC with the G-RNTI. For each multicast transmission, after the UE 102 verifies the (scrambled) CRC is valid, the UE 102 receives the multicast transmission in accordance with the corresponding DCI and retrieves the particular MAC PDU from the multicast transmission. In this case, each multicast transmission is a dynamic scheduling multicast transmission used in the following description. In some implementations, each DCI includes configuration parameters configuring a dynamic scheduling multicast radio resource scheduling the corresponding multicast transmission. In some implementations, the configuration parameters can include at least one of the following parameters. The configuration parameters of the each DCI can include the same values and/or different values for the following configuration parameters: (i) frequency domain resource assignment, (ii) time domain resource assignment, (iii) virtual resource block (VRB)-to-physical resource block (PRB) mapping, (iv) modulation and coding scheme (MCS), (v) new data indicator, (vi) redundancy version, (vii) HARQ process number, (viii) downlink assignment index, and/or (ix) PUCCH resource indicator.

In some implementations, the configuration parameters include a HARQ codebook (ID), which indicates a HARQ acknowledgement (ACK) codebook index for a corresponding HARQ ACK codebook for a dynamic scheduling multicast transmission received by the UE 102. The DU 174 uses the HARQ codebook (ID) to receive a HARQ ACK. In some cases where the configuration parameters do not include the HARQ codebook (ID), the UE 102 and DU 174 use a HARQ codebook (ID) for unicast transmission. In some implementations, the UE 102 receives the HARQ codebook (ID) for unicast transmission in the DU configuration from the DU 174. In other implementations, the UE 102 receives the HARQ codebook (ID) for unicast transmission in another DU configuration from the DU 174, similar to events 516, 518 and 520.

In some implementations, the configuration parameters include a PUCCH resource configuration, which indicates a HARQ resource on a PUCCH where the UE 102 transmits a HARQ feedback (e.g., HARQ ACK and/or negative ACK (NACK)) for a dynamic scheduling multicast transmission. In some cases where the configuration parameters do not include the PUCCH resource configuration, the UE 102 and DU 174 use a PUCCH resource configuration for unicast transmissions to communicate HARQ feedback.

In some implementations, the configuration parameters include a HARQ NACK-only indication, which configures the UE 102 to only transmit a HARQ negative ACK (NACK) for a dynamic scheduling multicast transmission that the UE 102 receives from the DU 174 and from which the UE 102 fails to obtain a transport block. In some implementations, the UE 102 fails to obtain the transport block because the UE 102 fails a cyclic redundancy check (CRC) for the transport block or the UE 102 does not receive the dynamic scheduling multicast transmission. In accordance with the indication, the UE 102 refrains from transmitting to the DU 174 a HARQ ACK for a dynamic scheduling multicast transmission that the UE 102 successfully receives and from which the UE 102 obtains a transport block. In some cases where the configuration parameters do not include the indication, the UE 102 transmits to the DU 174 a HARQ ACK for a dynamic scheduling multicast transmission that the UE 102 successfully receives and from which the UE 102 obtains a transport block.

In some implementations, the configuration parameters include a HARQ ACK/NACK indication, which configures the UE 102 to transmit a HARQ NACK for a dynamic scheduling multicast transmission. In such implementations, the UE 102 fails to obtain a transport block and configures the UE 102 to transmit a HARQ ACK for a dynamic scheduling multicast transmission that the UE 102 successfully receives, and from which the UE 102 obtains a transport block. In cases where the configuration parameters do not include the indication, the UE 102 refrains from transmitting to the DU 174 a HARQ ACK for a dynamic scheduling multicast transmission that the UE 102 successfully receives, and from which the UE 102 obtains a transport block. In some such cases, the UE 102 transmits, to the DU 174, a HARQ NACK for a dynamic scheduling multicast transmission only where the UE 102 fails to obtain a transport block.

In some implementations, the configuration parameters include a HARQ ACK indication, which configures the UE 102 to transmit a HARQ ACK for a dynamic scheduling multicast transmission that the UE 102 successfully receives and from which the UE 102 obtains a transport block. In cases where the configuration parameters do not include the indication, the UE 102 refrains from transmitting to the DU 174 a HARQ ACK for a dynamic scheduling multicast transmission where the UE 102 successfully obtains a transport block. In some such cases, the UE 102 transmits, to the DU 174, a HARQ NACK for a dynamic scheduling multicast transmission only where the UE 102 fails to obtain a transport block. In some implementations, the DU 174 includes at least one of the HARQ NACK indication, HARQ ACK/NACK indication, and/or HARQ ACK indication.

In some implementations, the configuration parameters include a modulation and coding scheme (MCS) configuration, which indicates an MCS table that the DU 174 uses to transmit dynamic scheduling multicast transmissions, and the UE 102 uses to receive dynamic scheduling multicast transmissions. For example, the MCS table can be a MCS table defined in 3GPP specification 38.214 (e.g., a low-SE 64QAM table indicated in Table 5.1.3.1-3 of 3GPP TS 38.214 or a new table specific for multicast transmission). In some implementations, if DU 174 does not include the MCS configuration in the DU configuration, the UE 102 and DU 174 applies an MCS table predefined in 3GPP specification 38.214. For example, the predefined MCS table can be a 256QAM table or a 64QAM table, e.g., indicated in Table 5.1.3.1-2 or non-low-SE 64QAM table indicated in Table 5.1.3.1-1 of the specification 38.214, respectively. In some cases where the DU 174 does not include the MCS configuration in the DU configuration, the UE 102 and DU 174 apply an MCS table for unicast transmission to receive dynamic scheduling multicast transmissions from the DU 174. In some implementations, the DU 174 includes, in the DU configuration, a PDSCH configuration (e.g., PDSCH-Config) configuring the MCS table for unicast transmissions. In other implementations, the DU 174 transmits, to the UE 102, another DU configuration including the PDSCH configuration, similar to events 516, 518, and 520.

In some implementations, the configuration parameters include an aggregation factor, which is the number of repetitions for dynamic scheduling multicast transmission(s). In some such implementations, the DU 174 transmits (i.e., multicast) a number of repetitions of a dynamic scheduling multicast transmission in accordance with the aggregation factor, and the UE 102 receives the repetitions based on the aggregation factor. In some cases where the DU 174 does not include the aggregation factor in the DU configuration, the UE 102 applies an aggregation factor for unicast transmission(s). In some implementations, the DU 174 includes the aggregation factor for unicast transmission(s) to the UE 102 in the DU configuration. In other implementations, the DU 174 transmits another DU configuration including the aggregation factor for unicast transmissions to the UE 102, similar to events 516, 518, and 520.

The RRC reconfiguration messages for UEs joining the first MBS session include the same configuration parameters for receiving MBS data of the first MBS session. In some implementations, the RRC reconfiguration messages for the UEs include the same or different configuration parameters for receiving non-MBS data.

In some implementations, the configuration parameters can include at least one semi-persistent scheduling (SPS) multicast configuration for the UE 102 to receive 536 MBS data of the first MBS session. Each of the at least one SPS multicast configuration can include at least one of the below parameters for SPS multicast transmissions.

In some implementations, the configuration parameters include a group configured scheduling radio network temporary identifier (G-CS-RNTI), which is used to activate or release an SPS multicast radio resource. The DU 174 activates an SPS multicast radio resource for the UE 102 by generating an SPS multicast radio resource activation command (i.e., a DCI), scrambling a CRC of the DCI with the G-CS-RNTI, and transmitting the DCI and the scrambled CRC on a PDCCH. After activating the SPS multicast radio resource, the DU 174 periodically transmits a multicast transmission on the SPS multicast radio resource in accordance with the DCI, similar to the G-RNTI above, but for SPS radio resources.

In some implementations, the configuration parameters include a periodicity element, which indicates a periodicity of the SPS multicast radio resource.

In some implementations, the configuration parameters include a number of HARQ processes, which indicates a number of HARQ processes for communicating SPS multicast transmissions. The DU 174 uses at most the number of HARQ processes to transmit SPS multicast transmissions, and the UE 102 uses at most the number of HARQ processes to receive the SPS multicast transmissions.

In some implementations, the configuration parameters include a HARQ codebook ID for SPS multicast radio resources and transmission, as described above with regard to dynamic scheduling. In some implementations, the configuration parameters include a HARQ process ID offset, which indicates an offset used in deriving HARQ process IDs for the DU 174 to transmit SPS multicast transmissions and for the UE 102 to receive SPS multicast transmissions.

In some implementations, the configuration parameters include a PUCCH resource configuration, a HARQ NACK-only indication, a HARQ ACK/NACK indication, a HARQ ACK indication, an aggregation factor, and/or an MCS configuration for SPS multicast transmission, similar to the parameters described above with regard to dynamic scheduling.

In some implementations, the configuration parameters include a first multicast DRX configuration (e.g., DRX-ConfigPTM-r17 IE) configuring first multicast DRX operation. The first multicast DRX configuration includes at least one of the below first multicast DRX parameters.

In some implementations, the multicast DRX configuration includes an on-duration length (value), which is a length of an on-duration for a first multicast DRX cycle. In some implementations. In some implementations, the on-duration length is a drx-onDurationTimerPTM field in the DRX-ConfigPTM-r17 IE.

In further implementations, the multicast DRX configuration includes a DRX slot offset, which specifies an offset to the first slot (i.e., starting slot) of the on-duration, e.g., the delay before the on-duration starts. In some implementations, the DRX offset is a drx-SlotOffsetPTM field in the DRX-ConfigPTM-r17 IE.

In still further implementations, the multicast DRX configuration includes a DRX inactivity timer (value), which is a duration after a PDCCH occasion in which a DCI indicates a new DL multicast transmission. In some implementations, the DRX inactivity timer value is included in a drx-InactivityTimerPTM field in the DRX-ConfigPTM-r17 IE.

In yet further implementations, the multicast DRX configuration includes a DRX cycle length, which is a length of the first multicast DRX cycle. The DRX cycle length specifies a periodic repetition of the on-duration followed by a period of inactivity (e.g., off-duration).

In further implementations, the multicast DRX configuration includes a DRX cycle start offset that defines a subframe where the first multicast DRX cycle starts. In some implementations, the DRX cycle length and DRX cycle start offset combine as a compound configuration (e.g., drx-LongCycleStartOffsetPTM field in the DRX-ConfigPTM-r17 IE). In some such implementations, if [(SFN×10)+subframe number] modulo (drx-LongCycle-PTM)=drx-StartOffset-PTM, then the UE 102 starts a drx-onDurationTimerPTM timer after drx-SlotOffsetPTM from the beginning of the subframe.

In still further implementations, the multicast DRX configuration includes a DRX retransmission timer (value) for multicast, which defines the maximum duration until a DL multicast retransmission is received. In some implementations, the timer value is included in a drx-RetransmissionTimerDL-PTM field in the DRX-ConfigPTM-r17 IE.

In yet further implementations, the multicast DRX configuration includes a DRX HARQ round trip time (RTT) timer (value) for multicast that defines the minimum duration before a DL multicast assignment for HARQ retransmission is expected by the UE 102A. In some implementations, the timer value is included in a drx-HARQ-RTT-TimerDL-PTM field in the DRX-ConfigPTM-r17 IE.

In some implementations, the DU 174 generates the first multicast DRX configuration based on QoS configuration parameters for the first MBS session. In other implementations, the DU 174 generates the first multicast DRX configuration, based on MBS traffic characteristics for the first MBS session. In yet other implementations, the DU 174 generates the first multicast DRX configuration based on QoS configuration parameters and MBS traffic characteristics for the first MBS session.

In yet other implementations, the DU 174 generates the first multicast DRX configuration based on an MBS ID. In some such implementations, the MBS ID is the first MBS session ID. In further implementations, the MBS ID is an MRB ID of an MRB associated with the first MBS session (ID). In some such implementations, the DU 174 is preconfigured with a list of MBS ID(s), each associated with a particular multicast DRX configuration. When the DU 174 receives the MBS ID in the first CU-to-DU message of event 506 or the UE Context Request message of event 522, the DU 174 looks up the list with the MBS ID to identify or determine a particular preconfigured multicast DRX configuration. The DU 174 then generates the first multicast DRX configuration based on the preconfigured multicast DRX configuration. For example, the first multicast DRX configuration can be the same as the preconfigured multicast DRX configuration.

In some implementations, the CU-CP 172A indicates or configures information related to configuring DRX, such as desired value(s) for at least one of the first multicast DRX parameters, in one of the CU-to-DU messages of the procedure 592A (e.g., the message of event 506 or 516). In further implementations, the CU-CP 172A includes the desired value(s) in the UE Context Request message of event 506. In other implementations, the CU-CP 172A includes the desired value(s) in a UE associated CU-to-DU message (e.g., the message of event 522 or the third CU-to-DU message). In such cases, the DU 174 uses the desired value(s) for the at least one of the first multicast DRX parameters. In some implementations, the first multicast DRX parameters include the DRX cycle length. If the CU-CP 172A does not provide a desired value for a particular one of the first multicast DRX parameters, the DU 174 determines a value for the particular multicast DRX parameter based on QoS parameters, MBS traffic characteristics and/or MBS ID as described above.

In some implementations, the CU-CP 172A determines whether to configure multicast DRX operation for an MBS session. If the CU-CP 172A determines to configure multicast DRX operation for the MBS session, the CU-CP 172A includes desired value(s) for multicast DRX parameter(s) (e.g., similar to the first multicast DRX parameter(s)) in a CU-to-DU message that the CU-CP 172A sends to the DU 174. The DU 174 generates a MBS DRX configuration for the multicast DRX operation in response to receiving the CU-to-DU message, including desired value(s) for multicast DRX parameter(s). For example, the CU-CP 172A determines to configure the first multicast DRX operation for the first MBS session. In response to the determination, the CU-CP 172A includes the desired value(s) for the first multicast DRX parameters in the first CU-to-DU message of event 506. The DU 174 generates the first MBS DRX configuration in response to receiving the first CU-to-DU message. If the CU-CP 172A determines not to configure multicast DRX operation for the MBS session, the CU-CP 172A refrains from including desired value(s) for multicast DRX parameter(s) in a CU-to-DU message that the CU-CP 172A sends to the DU 174. The DU 174 refrains from generating an MBS DRX configuration for the MBS session in response to receiving the CU-to-DU message excluding desired value(s) for multicast DRX parameter(s). For example, the CU-CP 172A determines not to configure multicast DRX operation for the first MBS session. In response to the determination, the CU-CP 172A refrains from including desired value(s) for the multicast DRX parameter(s) in the first CU-to-DU message of event 506. The DU 174 refrains from generating an MBS DRX configuration for the first MBS session in response to receiving the first CU-to-DU message excluding desired value(s) for multicast DRX parameter(s).

The UE 102 and DU 174 perform the first multicast DRX operation in accordance with the first multicast DRX configuration. In some implementations, the UE 102 and DU 174 communicates 536 the MBS data in accordance with the first multicast DRX configuration. For example, the DU 174 transmits 536 to the UE 102 the multicast transmissions including the MBS data in slots within the on-duration(s) in at least one instance of the first multicast DRX cycle. The UE 102 receives 536 from the DU 174 the multicast transmission in slots within the on-duration(s) in at least one instance of the first multicast DRX cycle.

In some implementations, the first multicast DRX configuration is associated with the G-RNTI or G-CS-RNTI. The UE 102 monitors a PDCCH from the DU 174 using a MAC entity (e.g., MAC 204B), the G-RNTI or G-CS-RNTI, discontinuously in accordance with first the multicast DRX operation, and Active Time as described below. The Active Time includes the time, while a drx-onDurationTimerPTM, a drx-InactivityTimerPTM or a drx-RetransmissionTimerDL-PTM for the G-RNTI or G-CS-RNTI is running. In further implementations, if the MAC 204B is configured with the DRX HARQ RTT timer value for unicast, then the UE 102 starts a drx-HARQ-RTT-TimerDL. Similarly, in implementations where the drx-RetransmissionTimerDL timer is configured and started, then the UE 102 stops a drx-RetransmissionTimerDL. If the UE 102 receives a DRX command MAC control element in a transmission scheduled by a DCI on a PDCCH addressed by the G-RNTI or G-CS-RNTI, then the UE 102 stops a drx-onDurationTimerPTM timer of the DRX for the G-RNTI.

As such, in some implementations, if the UE 102 receives a MAC PDU in accordance with a configured downlink multicast assignment, then, if HARQ feedback is enabled, the UE 102 starts a HARQ RTT timer (e.g., a drx-HARQ-RTT-TimerDL-PTM timer) for the corresponding HARQ process in the first symbol after the end of the corresponding transmission carrying the DL HARQ feedback. Additionally or alternatively, the UE 102 starts a HARQ RTT timer (e.g., a drx-HARQ-RTT-TimerDL timer) for the corresponding HARQ process in the first symbol after the end of the corresponding transmission carrying the DL HARQ feedback if the MAC entity is configured with the DRX HARQ RTT timer value for unicast. The UE 102 then, in further implementations, stops a retransmission timer (e.g., a drx-RetransmissionTimerDL-PTM timer) for the corresponding HARQ process. Additionally or alternatively, the UE 102 stops a drx-RetransmissionTimerDL timer for the corresponding HARQ process, if the drx-RetransmissionTimerDL timer is configured and started. In further implementations, if a HARQ RTT timer (e.g., a drx-HARQ-RTT-TimerDL-PTM timer) expires and if the data of the corresponding HARQ process was not successfully decoded, the UE 102 starts the retransmission timer (e.g., a drx-RetransmissionTimerDL-PTM timer) for the corresponding HARQ process in the first symbol after the expiry of the HARQ RTT timer (e.g., the drx-HARQ-RTT-TimerDL-PTM timer).

Moreover, in further implementations, if the MAC entity is in Active Time for the G-RNTI or G-CS-RNTI, the UE 102 monitors a PDCCH for this G-RNTI or G-CS-RNTI (e.g., as specified in 3GPP specification 38.213). In further implementations, if the PDCCH indicates a DL multicast transmission, then, if HARQ feedback is enabled, the UE 102 starts the HARQ RTT timer(s) (e.g., a drx-HARQ-RTT-TimerDL-PTM timer and/or a drx-HARQ-RTT-TimerDL timer) for the corresponding HARQ process in the first symbol after the end of the corresponding transmission carrying the DL HARQ feedback. The UE 102, In further implementations, additionally or alternatively stops retransmission timer(s) (e.g., the drx-RetransmissionTimerDL-PTM timer and/or the drx-RetransmissionTimerDL timer) for the corresponding HARQ process. If the PDCCH indicates a new multicast transmission for the G-RNTI or the G-CS-RNTI, the UE 102 starts or restarts an inactivity timer (e.g., a drx-InactivityTimerPTM timer) in the first symbol after the end of the PDCCH reception.

The DU 174 can perform an early termination of an on-duration in a particular instance of the first multicast DRX cycle by transmitting a DRX command to the UE 102. To transmit the DRX command to the UE 102, the DU 174 generates a MAC PDU including the DRX command and a subheader for the DRX command. To schedule a multicast transmission of the MAC PDU, the DU 174 generates a DCI, generates a CRC for the DCI, and scrambles the CRC with the G-RNTI or G-CS-RNTI. The DU 174 transmits the DCI and scrambled CRC on a PDCCH and transmits the multicast transmission in accordance with the DCI. Upon receiving the DCI and scrambled CRC, the UE 102 verifies whether the scrambled CRC is valid or not. In some implementations, if the UE 102 verifies that the scrambled CRC is valid, the UE 102 receives or attempts to receive the multicast transmission in accordance with the DCI. The UE 102 then decodes the multicast transmission to obtain the MAC PDU in accordance with the DCI and retrieves the DRX command from the MAC PDU. Otherwise, if the UE 102 verifies that the scrambled CRC is invalid, the UE 102 refrains from receiving or attempting to receive the multicast transmission in accordance with the DCI. In other implementations, the UE 102 receives the multicast transmission in accordance with the DCI before verifying the scrambled CRC. If the UE 102 verifies that the scrambled CRC is valid, the UE 102 decodes or attempts to decode the multicast transmission to obtain the MAC PDU in accordance with the DCI and retrieves the DRX command from the MAC PDU. Otherwise, if the UE 102 verifies that the scrambled CRC is invalid, the UE 102 refrains from decoding or attempting to decode the multicast transmission in accordance with the DCI.

In some implementations, the CU-CP 172A includes the MBS session join response message in the RRC reconfiguration message. The UE 102 can include the MBS session join complete message in the RRC reconfiguration complete message. Alternatively, the UE 102 sends a UL RRC message including the MBS session join complete message to the CU-CP 172A via the DU 174. The UL RRC message can be a ULInformationTransfer message or any suitable RRC message that can include a UL NAS PDU. In some implementations, the CU-CP 172A includes the MBS session join complete message in the second BS-to-CN message. Alternatively, the CU-CP 172A sends, to the CN 110, a BS-to-CN message (e.g., an UPLINK NAS TRANSPORT message) including the MBS session join complete message.

In other implementations, the CU-CP 172A transmits a DL RRC message that includes the MBS session join response message to the UE 102. The DL RRC message can be a DLInformationTransfer message, another RRC reconfiguration message, or any suitable RRC message that can include a DL NAS PDU. The UE 102 sends a UL RRC message including the MBS session join complete message to the CU-CP 172A via the DU 174. The UL RRC message can be an ULInformationTransfer message, another RRC reconfiguration complete message or any suitable RRC message that can include a UL NAS PDU.

The events 532, 534, and 536 are collectively referred to in FIG. 5A as an MBS session data transmission procedure 596.

In some cases where the CU-CP 172A does not receive slice information from the CN 110, the CU-CP 172A includes preconfigured slice information in the first CP-to-UP message of event 560. In some cases where the CU-CP 172A does not receive slice information from the CN 110, the CU-CP 172A includes preconfigured slice information in the first CU-to-DU message of event 506.

FIG. 5B illustrates an example scenario 500B similar to the scenarios 500A illustrated in FIG. 5A. In the scenario 500B, the CN 110 sends 503 a first CN-to-BS message (e.g., Multicast Session Activation Request message) including the first MBS session ID to the CU-CP 172A to request the CU-CP 172A to configure or activate resources for the first MBS session (i.e., a multicast (MBS) session). In this scenario, the CN 110 does not include MBS QoS flow configuration(s) for the first MBS session in the first CN-to-BS message. Thus, the CU-CP 172A generates the second MBS QoS flow configuration(s) based on preconfigured MBS QoS flow configuration(s). For example, the second MBS QoS flow configuration(s) are the same as the preconfigured MBS QoS flow configuration(s). In another example, the second MBS QoS flow configuration(s) are similar to the preconfigured MBS QoS flow configuration(s).

In some implementations, the CU-CP 172A is preconfigured with the preconfigured MBS QoS flow configuration(s) before receiving the first CN-to-BS message. In other implementations, the CU-CP 172A receives the preconfigured MBS QoS flow configuration(s) from an Operations, Administration and Maintenance (OAM) node before receiving the first CN-to-BS message. Examples or implementations described for the first MBS QoS flow configuration(s) can apply to the preconfigured MBS QoS flow configuration(s).

The events 503, 560, 562, 506, 508, 510, 512, 514, 564, 566, 516, and 518 are collectively referred to in FIG. 5B as an MBS session resource setup procedure 592B.

FIG. 5C illustrates an example scenario 500C similar to the scenarios 500A-B illustrated in FIGS. 5A-B respectively. In the scenario 500C, the CN 110 includes the first MBS QoS flow configuration(s) in the second CN-to-BS message of event 514. In this case, the CN 110 does not include the first MBS QoS flow configuration(s) in the first CN-to-BS message. After receiving the second CN-to-BS message, the CU-CP 172A sends 560 the first CP-to-UP message and 506 the first CU-to-DU message to the CU-UP 172B and DU 174, respectively. In other words, the CU-CP 172A delays sending the first CP-to-UP message and first CU-to-DU message (e.g., delays performing the MC Bearer Context Setup procedure and the Multicast Context Setup procedure) until receiving the first MBS QoS flow configuration(s) or the second CN-to-BS message.

The events 503, 512, 514, 560, 562, 506, 508, 510, 564, 566, 516, and 518 are collectively referred to in FIG. 5C as an MBS session resource setup procedure 592C.

In some implementations, the CN 110 includes the first slice information in the second CN-to-BS message of event 514. In some such cases, the CN 110 does not include the first slice information in the first CN-to-BS message. In some implementations, the CN 110 includes the first MBS area information in the second CN-to-BS message of event 514. In some such cases, the CN 110 does not include the first MBS area information in the first CN-to-BS message.

FIG. 5D illustrates an example scenario 500D similar to the scenarios 500A-C illustrated in FIGS. 5A-C respectively. In the scenario 500D, the CN 110 sends 505 to the CU-CP 172A a fourth CN-to-BS message (e.g., a Multicast Session Update Request message) including the first MBS session ID and the first MBS QoS flow configuration(s) after sending 503 the first CN-to-BS message. After receiving the fourth CN-to-BS message, the CU-CP 172A sends 560 the first CP-to-UP message and 506 the first CU-to-DU message to the CU-UP 172B and DU 174, respectively. In other words, the CU-CP 172A delays sending the first CP-to-UP message and first CU-to-DU message (e.g., delay performing the MC Bearer Context Setup procedure and the Multicast Context Setup procedure) until receiving the first MBS QoS flow configuration(s) or the fourth CN-to-BS message. In some implementations, the CU-CP 172A sends 519 a fourth BS-to-CN message (e.g., a Multicast Session Update Response message) to the CN 110 in response to the fourth CN-to-BS message.

In some implementations, the CU-CP 172A sends 519, to the CN 110, the fourth BS-to-CN message upon receiving 503 the first CN-to-BS message. In other implementations, the CU-CP 172A sends 518 the second BS-to-CN message to the CN 110 before or after receiving 514 the second CN-to-BS message, receiving 566 the second UP-to-CP message or transmitting 516 the second CU-to-DU message. In some implementations, the CU-CP 172A sends 518 to the CN 110 the second BS-to-CN message before receiving 505 the fourth CN-to-BS message or sending 519 the fourth BS-to-CN message. In other implementations, the CU-CP 172A sends 518 the second BS-to-CN message to the CN 110 after receiving 505 the fourth CN-to-BS message or sending 519 the fourth BS-to-CN message.

In some implementations, the CN 110 includes the first slice information in the fourth CN-to-BS message of event 505. In some such cases, the CN 110 does not include the first slice information in the first CN-to-BS message. In some implementations, the CN 110 includes the first MBS area information in the fourth CN-to-BS message of event 505. In some such cases, the CN 110 does not include the first MBS area information in the first CN-to-BS message.

FIG. 5E illustrates an example scenario 500E similar to the scenarios 500A-D illustrated in FIGS. 5A-D respectively. In the scenario 500E, the CN 110 includes the first MBS QoS flow configuration(s) in the third CN-to-BS message of event 520 and the CN 110, CU-CP 172A, CU-CP 172A and DU 174 then performs 592E the MBS session resource configuration procedure, similar to the procedure 592B except that the CU-CP 172A generates the second MBS QoS flow configuration(s) based on the first MBS QoS flow configuration(s) as described for FIG. 5A.

In some implementations, the CN 110 includes the first slice information in the third CN-to-BS message of event 520. In some such cases, the CN 110 does not include the first slice information in the first CN-to-BS message. In some implementations, the CN 110 includes the first MBS area information in the third CN-to-BS message of event 520. In some such cases, the CN 110 does not include the first MBS area information in the first CN-to-BS message.

FIG. 5F illustrates an example scenario 500F similar to the scenarios 500A-E illustrated in FIGS. 5A-E respectively. In the example scenario 500E, however, the UE 103 joins both a second MBS session (as in the example scenario 500A) and a first MBS session (i.e., the same MBS session joined by the UE 102 in procedure 502). A node of the RAN 105 or UE 102 identifies the second MBS session by a second MBS session ID (i.e., session ID 2). More specifically, the UE 103 can perform 501 an MBS session join procedure for the second MBS session, and can perform 503 an MBS session join procedure for the first MBS session. The base station 104 and the CN 110 then perform 591 an MBS session resource setup procedure for the second MBS session, similar to the procedure 592A, 592B, 592C, 592D or 592E. The UE 103, the base station 104, and the CN 110 perform 593 a UE-specific MBS session configuration procedure for the second MBS session, similar to the procedure 594. Furthermore, the UE 103, the base station 104, and the CN perform 595 a UE-specific MBS session configuration procedure for the first MBS session, similar to the procedure 594.

The UE 103 joins the same MBS session as the UE 102 by specifying the same MBS session ID in the MBS session join request (e.g., the first MBS session ID). In the example scenario 500F, the UE 103 joins the first MBS session after the CN 110 and/or the base station 104 have started transmitting 596 MBS data for the first MBS session to the UE 102. During or after the procedure 503, the CU-CP 172A or CN 110 determines that a DL tunnel for the first MBS session already exists, and that there is no need to perform the procedure 591. The CU-CP 172A transmits a first RRC reconfiguration message to the UE 103 via the DU 174 to configure the UE 103 to receive MBS traffic for the second MBS session. In response, the UE 103 transmits a first RRC reconfiguration complete message to the CU-CP 172A via the DU 174. The first RRC reconfiguration message can include a LCID (value), a MRB configuration, and a RLC bearer configuration for the second MBS session, different from the LCID (value), MRB configuration, and RLC bearer configuration for the first MBS session.

Similarly, the CU-CP 172A transmits a second RRC reconfiguration message to the UE 103 to configure the UE 103 to receive MBS traffic for the first MBS session. In response, the UE 103 transmits a second RRC reconfiguration complete message to the CU-CP 172A via the DU 174. The second RRC reconfiguration message can include the same LCID (value), MRB configuration, and RLC bearer configuration as for the UE 102, when the UEs 102 and 103 operate in the same cell or different cells. In some implementations when the UEs 102 and 103 operate in different cells, the second RRC reconfiguration message has a different, G-RNTI, LCID and/or RLC bearer configuration, for example. Alternatively, when the UEs 102 and 103 operate in different cells, the second RRC reconfiguration message has the same, G-RNTI, LCID and/or RLC bearer configuration. In further implementations, the second RRC reconfiguration message includes the same MRB configuration as for the UE 102, when the UEs 102 and 103 operate in different cells.

As illustrated in FIG. 3, the CU-UP 172B maps data packets arriving via the common CN-to-BS DL tunnel to one or more MRBs, each corresponding to a common CU-to-DU DL tunnel and/or a respective logical channel. Furthermore, depending on the implementation, the RRC reconfiguration message includes the same LCID (value), MRB configuration, and/or RLC bearer configuration for the first MBS session for UE 103 as the LCID (value), MRB configuration, and/or RLC bearer configuration for the second MBS session for the UE 103. Accordingly, in such implementations, the UE 103 and UE 102 receive MBS data for the first MBS session via the same logical channel(s) and/or MRB(s).

In any event, the CN 110 then sends 538, 544 MBS data for the first MBS session and MBS data for the second MBS session to the CU-UP 172B via different common CN-to-BS DL tunnels, respectively. Then the CU-UP 172B sends 540, 546 the MBS data for the first MBS session and the MBS data for the second MBS session to the DU 174 via different common CU-to-DU DL tunnels, respectively. The DU 174 transmits (e.g., multicast) 542 the MBS data for the second MBS session via one or more logical channels to the UE 103, and transmits (e.g., multicast) 548 the MBS data for the first MBS session via one or more logical channels to the UE 103 and UE 102. The UE 103 receives 548 the MBS data for the first MBS session and receives 542 the MBS data for the second MBS session via multicast, such that the UE 103 can receive two sets of MBS data for different MBS sessions. The UE 102 can receive 548 the MBS data for the first MBS session via multicast.

In some implementations, the CU-CP 172A includes a second multicast DRX configuration in the first RRC reconfiguration message to configure a second multicast DRX cycle. In other implementations, the CU-CP 172A transmits a third RRC reconfiguration message including the second multicast DRX configuration to the UE 103 via the DU 174. In response, the UE 103 transmits a third RRC reconfiguration complete message to the CU-CP 172A via the DU 174. The DU 174 transmits 542 MBS packets for the second MBS session in accordance with the second multicast DRX cycle, and the UE 103 receives 542 the MBS packets for the second MBS session in accordance with the second multicast DRX cycle.

In some implementations, the CU-CP 172A includes the first multicast DRX configuration in the second RRC reconfiguration message to configure the first multicast DRX cycle. In other implementations, the CU-CP 172A transmits a fourth RRC reconfiguration message including the first multicast DRX configuration to the UE 103 via the DU 174. In response, the UE 103 transmits a fourth RRC reconfiguration complete message to the CU-CP 172A via the DU 174. The DU 174 transmits 548 MBS packets for the first MBS session in accordance with the first multicast DRX cycle, and the UE 103 receives 548 the MBS packets for the first MBS session in accordance with the first multicast DRX cycle.

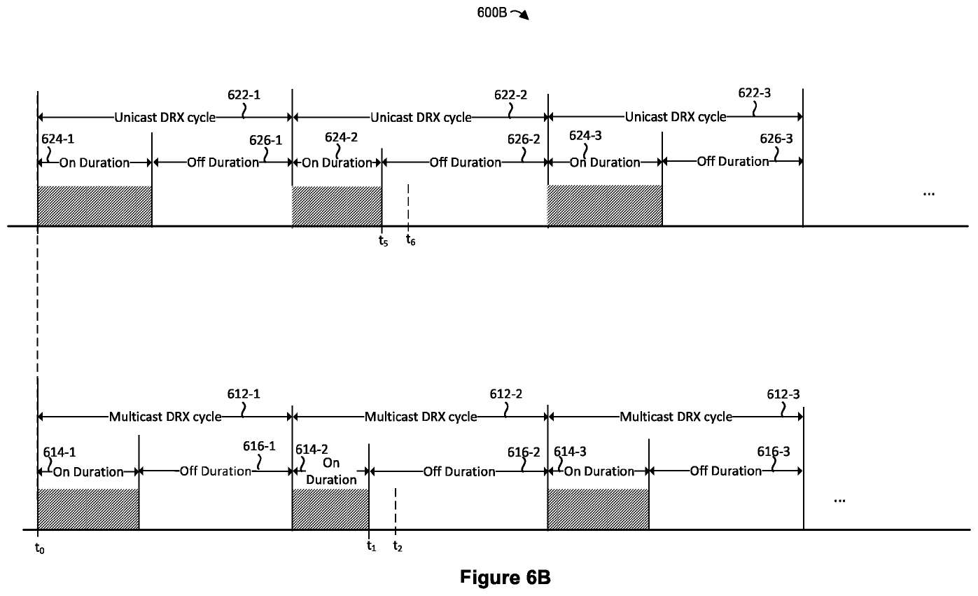

Next, several example timing diagrams illustrating messaging timing that may be implemented by devices illustrated in FIGS. 1A and/or 1B are discussed with reference to FIGS. 6A and 6B.

FIGS. 6A and 6B illustrate example scenarios 600A and 600B in which a DRX command cuts short an on-duration period. It will be understood that, by referring to “stopping an on-duration period” or “cutting short an on-duration period,” the instant disclosure refers to performing such by “stopping a timer associated with an on-duration period.” Similar operations of stopping other such periods are performed similarly. In particular, in scenario 600A, a UE 102 operates according to unicast DRX cycles 602-1, 602-2, and 602-3 (collectively referred to as “unicast DRX cycles 602”) as well as multicast DRX cycles 612-1, 612-2, and 612-3 (collectively referred to as “multicast DRX cycles 612”). Each unicast DRX cycle 602 includes an on-duration period 604-1, 604-2, and 604-3 (collectively referred to as “unicast on-duration periods 604”) as well as an off-duration period 606-1, 606-2, and 606-3 (collectively referred to as “unicast off-duration periods 606”). Similarly, each of the multicast DRX cycle 612 also includes an on-duration period 614-1, 614-2, and 614-3 (collectively referred to as “multicast on-duration periods 614”) as well as an off-duration period 616-1, 616-2, and 616-3 (collectively referred to as “multicast off-duration periods 616”). Similarly, in scenario 600B, a UE 102 operates according to unicast DRX cycles 622-1, 622-2, and 622-3 (collectively referred to as “unicast DRX cycles 622”) with on-duration period 624-1, 624-2, and 624-3 (collectively referred to as “unicast on-duration periods 624”) as well as an off-duration period 626-1, 626-2, and 626-3 (collectively referred to as “unicast off-duration periods 626”). Scenario 600B depicts the same multicast DRX cycle 612 shown in scenario 600A. The unicast DRX cycle 622 of scenario 600B are time-offset from those of scenario 600A and time-aligned with the multicast DRX cycle 612. During the unicast on-duration periods 604, 624 and/or multicast on-duration periods 614, the UE 102 is active to receive signals carrying messages and/or other data from a RAN 105. During the unicast off-duration periods 606, 626 and/or multicast off-duration periods 616, the UE 102 is instead inactive to save power when no messages and/or data are expected.

In some implementations, the CU-CP 172A transmits a desired DRX cycle length and/or other information regarding configuring the DRX cycle (e.g., a desired on-duration length, a desired off-duration length, a starting time, etc.) in a communication to the DU 174, such as events 506, 516, or 522 as described above with regard to FIGS. 5A-5F. In such implementations, the DU 174 configures the DRX cycle(s) for the UE 102 and transmits the DRX configuration(s) to the UE 102. In some implementations, the multicast DRX cycle 612 is specific to an MBS session. In further implementations, multiple MBS sessions share the multicast DRX cycle 612. In further implementations, the unicast DRX cycle 602, 622 is UE-specific. Depending on the implementation, the DU 174 configures the DRX cycle(s) such that the multicast DRX cycle 612 and the unicast DRX cycle 602, 622 of the UE 102 are in sync per scenario 600B or are desynched per scenario 600A, as described below.

In some implementations, when the RAN 105 determines that no data is being transmitted for the UE 102 and/or a base station 104 of the RAN 105 determines that no tunneling or uplink data is being transmitted between the UE 102 and the base station 104, the base station 104 can receive and/or generate a DRX Command to perform an early termination of the DRX cycle. In some such implementations, the base station 104 transmits a MAC PDU scheduled by a DCI with a CRC including the DRX Command. As described above, if the UE 102 receives the DRX command using a UE-specific RNTI, such as a C-RNTI or CS-RNTI, then the UE 102 determines that the DRX command is for a unicast cycle and terminates the on-duration early at t₃ (or t₅) instead of at the regular time of t₄ (or t₆). Similarly, if the UE 102 receives the DRX command using an MBS-specific RNTI, such as a G-RNTI or G-CS-RNTI, then the UE 102 determines that the DRX command is for a multicast cycle and terminates the on-duration early at t₁ instead of at the regular time of t₂.

In further implementations, a node of the RAN 105, such as the base station 104, monitors data traffic for the UE 102 and configures the length of the on-duration in accordance with the data traffic for either or both of the unicast DRX cycle and/or the multicast DRX cycle.

In scenario 600A, the unicast DRX cycles 602 do not align with the respective multicast DRX cycle counterparts 612, which starts at time to. As such, even though the UE 102 should enter an inactive state during an off-duration period 616-1 according to the multicast DRX cycle 612-1, the UE 102 remains or quickly becomes active due to the beginning of the on-duration period 604-1 of unicast DRX cycle 602-1. Similarly, although the on-duration period 614-2 is stopped at t₁ earlier than t₂ in response to receiving a DRX Command on a MAC PDU scheduled by a DCI with a CRC scrambled by G-RNTI or G-CS-RNTI, the inactivity period requested by the DRX command is shortened due to the beginning of the on-duration period 604-2 for the unicast DRX cycle. Similarly, the UE 102 stops the on-duration period 604-2 at t₃ earlier than t₄ in response to receiving a DRX Command on a MAC PDU scheduled by a DCI with a CRC scrambled by C-RNTI or CS-RNTI, but the inactivity for off-duration period 606-2 is cut short by the start of on-duration period 614-3. As such, the misaligned DRX cycles reduce overall power saving by the UE 102.

As such, in some implementations, if a DRX Command MAC control element (CE) is received in a transmission scheduled by a DCI on a PDCCH addressed by the G-RNTI or G-CS-RNTI (i.e., a CRC of the DCI is scrambled by the G-RNTI or G-CS-RNTI), the UE stops an on-duration timer (e.g., drx-onDurationTimerPTM) of the DRX and/or stops an inactivity timer (e.g., drx-InactivityTimerPTM) of the DRX for the G-RNTI/G-CS-RNTI.

In scenario 600B, the UE 102 operates according to the same multicast DRX cycles 612, but also operates according to an aligned set of unicast DRX cycles 622. Because the aligned unicast DRX cycles 622 also begin at to, the aligned unicast off-duration period 626 generally aligns more with the multicast off-duration period 616, which allows for greater uninterrupted inactivity during the respective off-duration periods. Similarly, even where the off-duration periods have different starting points, such as with off-duration period 626-2 stopped at t₅ earlier than t₆ in response to receiving a DRX Command and off-duration period 616-2 stopped at t₁ earlier than t₂, the resulting period of inactivity is still a greater uninterrupted length than the unaligned versions described in scenario 600A.

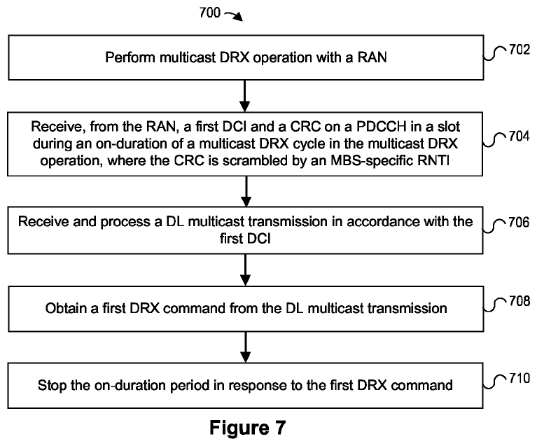

Next, several example methods that may be implemented by devices illustrated in FIGS. 1A and/or 1B are discussed with reference to FIGS. 7-17.

Referring first to FIG. 7, a method 700 can be implemented in a suitable UE and includes receiving a DCI and a CRC scrambled by an MBS-specific RNTI, subsequently receiving a DRX command, and stopping an on-duration period in response. For clarity, the method 700 is discussed with specific reference to the RAN 105, the BS 104, the CN 110, the UE 102, the PHY sublayer 202, and the MAC sublayer 204.

At block 702, the UE 102 performs a multicast DRX operation with a node of the RAN 105, such as BS 104 (e.g., events 536 or 596 of FIGS. 5A-5F). At block 704, the UE 102 receives, from the RAN 105, a DCI and a CRC (e.g., events 536 or 596 of FIGS. 5A-5F). Depending on the implementation, the UE 102 determines a type of DRX operation based on the CRC. In some implementations, an MBS-specific RNTI, such as G-RNTI or G-CS-RNTI, scrambles the CRC, which indicates a multicast type DRX operation to the UE 102. In further implementations, a UE-specific RNTI, such as C-RNTI or CS-RNTI, scrambles the CRC, which indicates a unicast type DRX operation to the UE 102. In further implementations, the UE 102 receives the DCI and/or the CRC on a PDCCH in a slot during an on-duration of a multicast DRX cycle.

At block 706, the UE 102 receives and processes a downlink multicast transmission in accordance with the DCI (e.g., events 536 or 596). At block 708, the UE 102 obtains DRX command from the downlink multicast transmission. In some implementations, the DRX command is an explicit command to stop the on-duration period. In further implementations, the DRX command is not an explicit command to stop the on-duration period, but instead ultimately the UE 102 stops the on-duration period. At block 710, the UE 102 stops the on-duration period in response to receiving the DRX command at block 708 (e.g., cycles 604-2, 614-2, or 624-2 of FIGS. 6A and 6B).

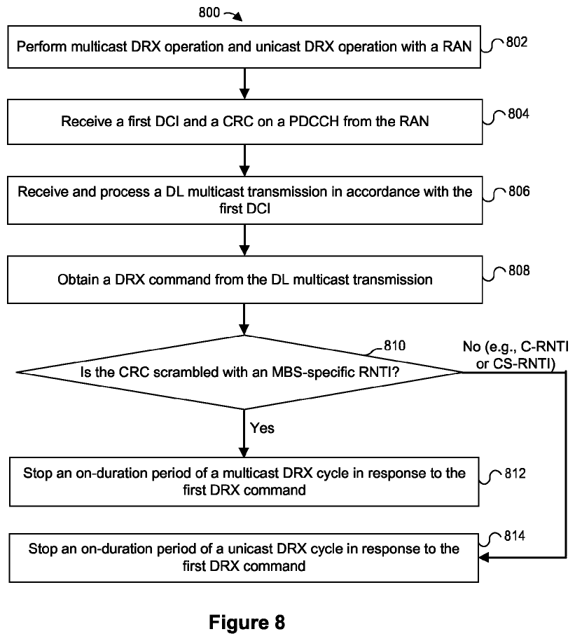

Referring next to FIG. 8, a method 800 can be implemented in a suitable UE and includes determining whether to stop an on-duration period of a multicast DRX cycle or a unicast DRX cycle based on whether an MBS-specific RNTI or a UE-specific RNTI scrambles the CRC. For clarity, the method 800 is discussed with specific reference to the RAN 105, the BS 104, the CN 110, the UE 102, the PHY sublayer 202, and the MAC sublayer 204.

At block 802, the UE 102 performs multicast DRX operation and unicast DRX operation with a node of the RAN 105, such as BS 104 (e.g., events 528, 530, 594, 536, or 596 of FIGS. 5A-5F). At block 804, the UE 102 receives a DCI and a CRC from the RAN 105, similar to block 704 of FIG. 7. At block 806, the UE 102 receives and processes a multicast transmission in accordance with the DCI, similar to block 706. Similarly, at block 808, the UE 102 obtains a DRX command from the multicast transmission as explained with regard to block 708. As such, examples and implementations described in the blocks of FIG. 7 also apply to the corresponding blocks of FIG. 8.

At block 810, the UE 102 determines whether an MBS-specific RNTI, such as G-RNTI or G-CS-RNTI, scrambled the CRC. If an MBS-specific RNTI scrambled the CRC, then flow continues to block 812, where the UE 102 stops an on-duration period of a multicast DRX cycle in response to the DRX command (e.g., cycle 614-2 of FIGS. 6A and 6B). If an MBS-specific RNTI did not scramble the CRC, then flow continues instead to block 814, where the UE 102 stops an on-duration period of a unicast DRX cycle in response to the DRX command (e.g., cycle 604-2 or 624-2 of FIGS. 6A and 6B). In some implementations, the flow continues to block 814 when a UE-specific RNTI, such as C-RNTI or CS-RNTI, scrambled the CRC.

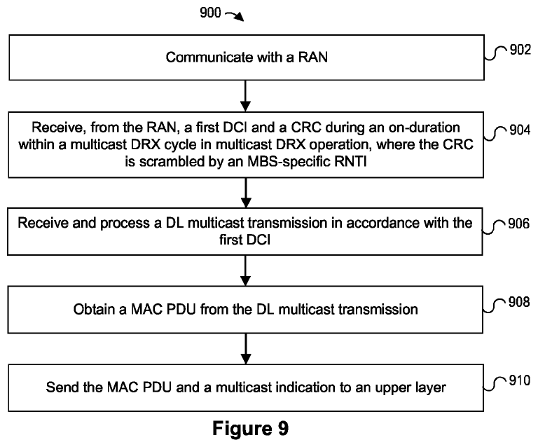

Referring next to FIG. 9, a method 900 can be implemented in a suitable PHY sublayer of a UE and includes receiving a DCI and a CRC scrambled by an MBS-specific RNTI, subsequently receiving a MAC PDU, and transmitting the MAC PDU to an upper layer. For clarity, the method 900 is discussed with specific reference to the RAN 105, the BS 104, the CN 110, the UE 102, the PHY sublayer 202, and the MAC sublayer 204.

At block 902, the UE 102 communicates with a RAN 105 at the PHY sublayer 202, similar to block 702 of FIG. 7. At block 904, the UE 102 receives a DCI and a CRC at the PHY sublayer 202 from the RAN 105, similar to block 704 of FIG. 7. At block 906, the PHY sublayer 202 of the UE 102 receives and processes a multicast transmission in accordance with the DCI, similar to block 706 of FIG. 7. As such, examples and implementations described in the blocks of FIG. 7 also apply to the corresponding blocks of FIG. 9.

At block 908, the PHY sublayer 202 of the UE 102 obtains a data packet from the multicast transmission. In some implementations, the data packet is a MAC PDU meant for an upper layer of the UE 102, such as the MAC sublayer 204. As such, at block 910, the PHY sublayer 202 of the UE 102 transmits the data packet to the upper layer, such as the MAC sublayer 204. In some implementations, the PHY sublayer 202 also transmits a multicast indication to the upper layer to indicate that the PHY sublayer 202 received the data packet via multicast transmission. In further implementations, if the MAC PDU includes a DRX command, the MAC sublayer 204 stops an on-duration period of a multicast DRX cycle in response to the multicast indication.

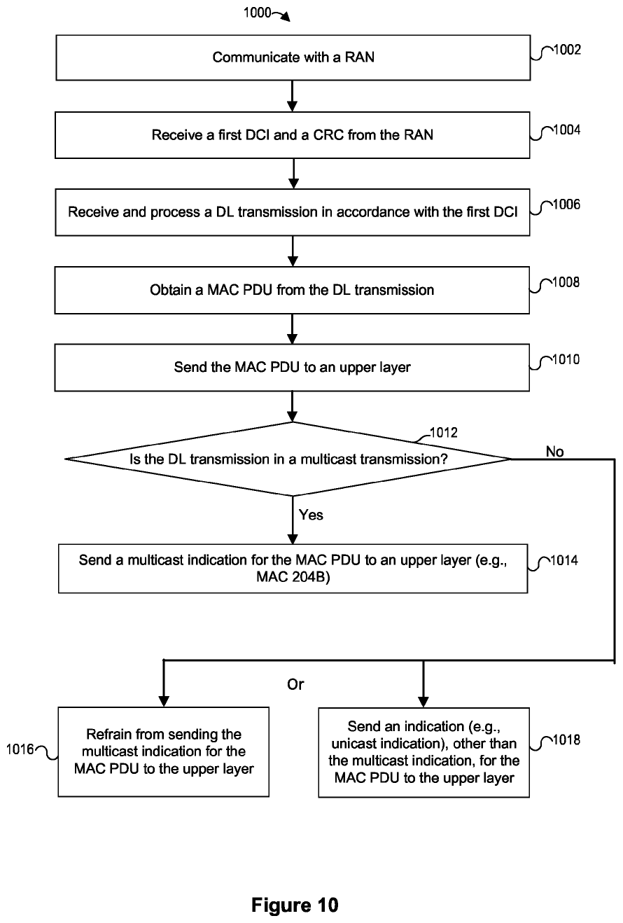

Referring next to FIG. 10, a method 1000 can be implemented in a suitable PHY sublayer of a UE and includes determining whether to transmit a multicast indication based on whether a downlink transmission from the RAN is a multicast transmission. For clarity, the method 1000 is discussed with specific reference to the RAN 105, the BS 104, the CN 110, the UE 102, the PHY sublayer 202, and the MAC sublayer 204. Portions of method 1000 are similar to the techniques described in method 900. In particular, blocks 1002, 1004, 1006, 1008, and 1010 are similar to blocks 902, 904, 906, 908, and 910 of FIG. 9. As such, examples and implementations described in the blocks of FIG. 9 also apply to the corresponding blocks of FIG. 10.

Contrasting with the example described at block 906, the UE 102 can receive and process a multicast or a unicast transmission. Then, at block 1008, the PHY sublayer 202 obtains a data packet, such as a MAC PDU, from the multicast or unicast transmission and, at block 1010, transmits the data packet to an upper layer of the UE 102, such as the MAC sublayer 204.

At block 1012, the UE 102 determines at the PHY sublayer 202 whether the transmission from the RAN 105 is a multicast transmission. If the RAN 105 transmission is a multicast transmission, then flow continues to block 1014, and the PHY sublayer 202 transmits a multicast indication for the data packet to an upper layer of the UE 102, such as the MAC sublayer 204. In some implementations, if the MAC PDU includes a DRX command, the MAC sublayer 204 stops an on-duration period of a multicast DRX cycle in response to the multicast indication. If the RAN 105 transmission is not a multicast transmission, then flow continues to block 1016 or 1018, depending on the implementation. At block 1016, the PHY sublayer 202 refrains from transmitting a multicast indication for the data packet to the upper layer of the UE 102. In some implementations, the lack of a transmission type indication indicates to the upper layer of the UE 102 that transmission was unicast, and thus acts as an implicit indication. In further implementations, if the MAC PDU includes a DRX command, the MAC sublayer 204 stops an on-duration period of a unicast DRX cycle in response to the implicit indication. In other implementations, the lack of a transmission type indication does not provide an implicit indication of the transmission type to the upper layer of the UE 102. At block 1018, the PHY sublayer 202 transmits an explicit non-multicast indication, such as a unicast indication, to the upper layer of the UE 102. In some implementations, if the MAC PDU includes a DRX command, the MAC sublayer 204 stops an on-duration period of a unicast DRX cycle in response to the non-multicast indication.

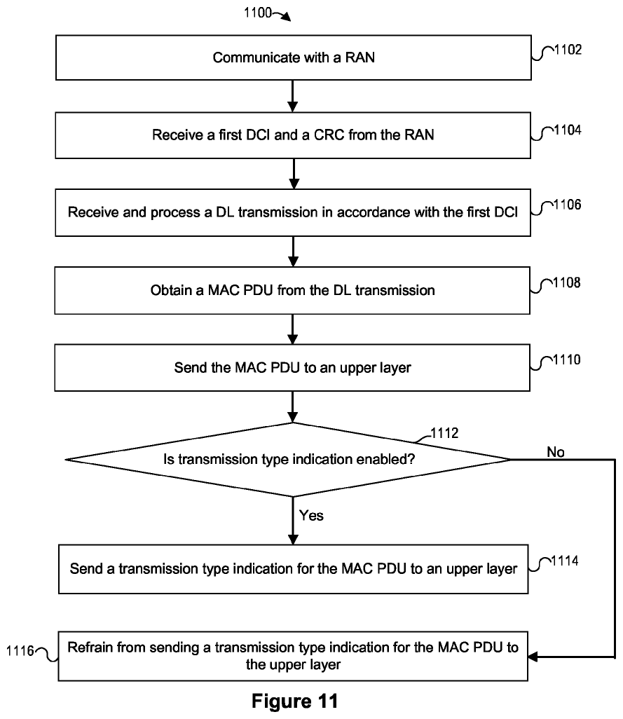

Referring next to FIG. 11, a method 1100 can be implemented in a suitable PHY sublayer of a UE and includes determining whether to transmit a transmission type indication to an upper layer based on whether a transmission type indication function is enabled. For clarity, the method 1100 is discussed with specific reference to the RAN 105, the BS 104, the CN 110, the UE 102, the PHY sublayer 202, and the MAC sublayer 204. Portions of method 1100 are similar to the techniques described in method 900. In particular, blocks 1102, 1104, 1106, 1108, and 1110 are similar to blocks 902, 904, 906, 908, and 910 of FIG. 9. As such, examples and implementations described in the blocks of FIG. 9 also apply to the corresponding blocks of FIG. 11.

Contrasting with the example described at block 906, the UE 102 may receive and process a multicast or a unicast transmission. Then, at block 1108, the PHY sublayer 202 obtains a data packet, such as a MAC PDU, from the multicast or unicast transmission and, at block 1110, transmits the data packet to an upper layer of the UE 102, such as the MAC sublayer 204.

At block 1112, the UE 102 determines at the PHY sublayer 202 whether a transmission type indication functionality is enabled for the PHY sublayer 202. If the transmission type indication functionality is enabled, then flow continues to block 1114, where the PHY sublayer 202 transmits a transmission type indication for the data packet to the upper layer of the UE 102. In some implementations, block 1112 occurs before 1110, and the PHY sublayer 202 transmits the data packet and the transmission type indication in a single message and/or set of messages. If the transmission type indication functionality is not enabled, then flow instead continues to block 1116, where the PHY sublayer 202 refrains from transmitting a transmission type indication for the data packet to the upper layer of the UE 102.

FIGS. 10 and 11 describe at least three different methods for indicating a transmission type to the upper layer of the UE 102: (a) the upper layer will assume a unicast transmission unless the PHY sublayer 202 includes a multicast indication (e.g., explicit multicast indication or implicit unicast indication to make a determination), (b) a lack of indication means a lack of support for type indication (e.g., explicit multicast indication or explicit unicast indication to make a determination), or (c) the upper layer will assume a multicast transmission unless the PHY sublayer 202 includes a unicast indication (e.g., explicit unicast indication or implicit multicast indication to make a determination).

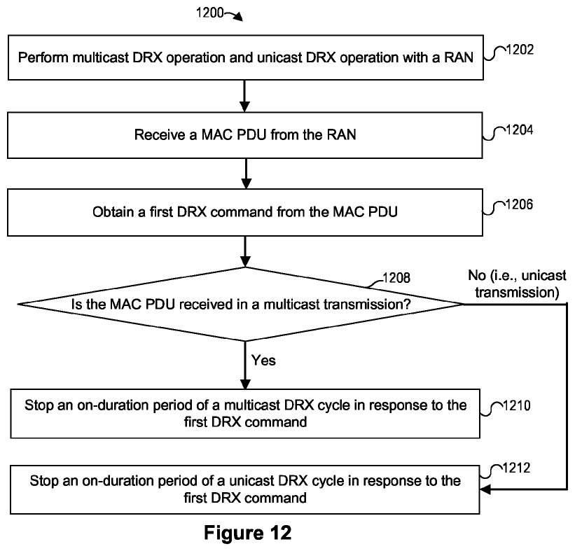

Referring next to FIG. 12, a method 1200 can be implemented in a suitable MAC sublayer of a UE and includes determining whether to stop an on-duration period of a multicast DRX cycle or a unicast DRX cycle based on whether the UE 102 received a MAC PDU in a multicast or unicast transmission. For clarity, the method 1200 is discussed with specific reference to the RAN 105, the BS 104, the CN 110, the UE 102, the PHY sublayer 202, and the MAC sublayer 204.

At block 1202, a MAC sublayer 204 of the UE 102 performs a multicast DRX operation and a unicast DRX operation with a node of the RAN, such as a BS 104 (e.g., event 528, 530, 594, 536, or 596 of FIGS. 5A-5F). At block 1204, the MAC sublayer 204 receives a data packet, such as a MAC PDU, from the RAN 105 (e.g., events 536 or 596 of FIGS. 5A-5F). In some implementations, the UE 102 receives the data packet at a PHY sublayer 202 and the PHY sublayer 202 transmits the data packet to the MAC sublayer 204, as described above with regard to FIGS. 9, 10, and 11. At block 1206, the MAC sublayer 204 obtains a DRX command from the data packet. In some implementations, the DRX command is an explicit command to stop the on-duration period. In further implementations, the DRX command is not an explicit command to stop the on-duration period, but instead ultimately the UE 102 stops the on-duration period.

At block 1208, the MAC sublayer 204 determines whether the UE 102 received the data packet in a multicast transmission. In some implementations, the MAC sublayer 204 makes the determination based on whether an indication of multicast or unicast transmission is present, as described with regard to FIG. 11 above. In implementations in which the UE 102 received the data packet in a multicast transmission, the flow continues to block 1210, where the MAC sublayer 204 stops an on-duration period of a multicast DRX cycle in response to the DRX command (e.g., cycle 614-2 of FIGS. 6A and 6B). If the UE 102 did not receive the data packet in a multicast transmission (i.e., the UE 102 received the data packet in a unicast transmission), the MAC sublayer 204 instead stops an on-duration period of a unicast DRX cycle in response to the DRX command (e.g., cycles 604-2 or 624-2 of FIGS. 6A and 6B).

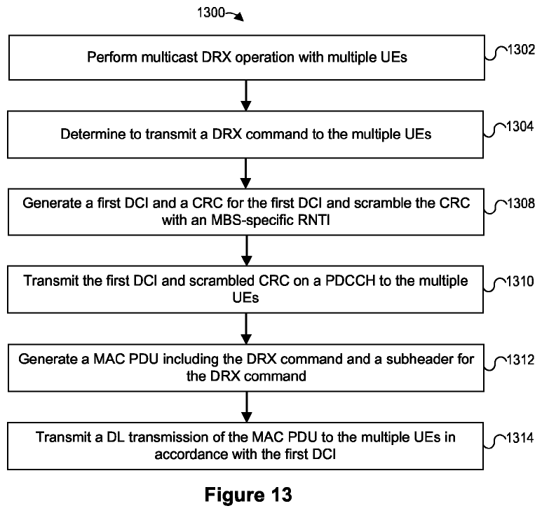

Referring next to FIG. 13, a method 1300 can be implemented in a suitable RAN and includes generating a DCI and scrambling a CRC with an MBS-specific RNTI and transmitting the DCI and CRC to UEs in the MBS session. For clarity, the method 1300 is discussed with specific reference to the RAN 105, the BS 104, the CN 110, the UE 102, the PHY sublayer 202, and the MAC sublayer 204.

At block 1302, the RAN 105 performs multicast DRX operation with a UE 102 (e.g., events 536 or 596 of FIGS. 5A-5F). In some implementations, the UE 102 is a first UE, and the RAN 105 performs multicast DRX operation with multiple UEs participating in the MBS session. At block 1304, the RAN 105 determines to transmit a DRX command to the UE 102 (or multiple UEs). Depending on the implementation, the RAN 105 selects a transmission scheme, such as MBS-specific RNTI, UE-specific RNTI, SPS, etc. based on the type of DRX operation to modify. For example, when modifying a multicast DRX cycle, the RAN 105 selects an MBS-specific RNTI or an SPS transmission scheme. When modifying a unicast DRX cycle, the RAN 105 selects a UE-specific RNTI. In some implementations, the DRX command is an explicit command to stop the on-duration period. In further implementations, the DRX command is not an explicit command to stop the on-duration period, but instead ultimately the UE 102 stops the on-duration period. At block 1308, the RAN 105 then generates a DCI and a CRC and scrambles the CRC. In some implementation, the RAN 105 scrambles the CRC with an MBS-specific RNTI, such as a G-RNTI or G-CS-RNTI.

At block 1310, the RAN 105 transmits the DCI and the scrambled CRC to the UE 102 (or multiple UEs) (e.g., events 536 or 596 of FIGS. 5A-5F). In some implementations, the RAN 105 transmits the DCI and the scrambled CRC on a PDCCH to each UE 102. At block 1312, the RAN 105 generates a data packet, such as a MAC PDU, including the DRX command. In some implementations, the data packet also includes a subheader for the DRX command. In further such implementations, the subheader is or includes an indication as to whether the DRX command is for a multicast DRX cycle or a unicast DRX cycle. At block 1314, the RAN 105 transmits the data packet to each UE 102 in accordance with the DCI (e.g., events 536 or 596 of FIGS. 5A-5F).

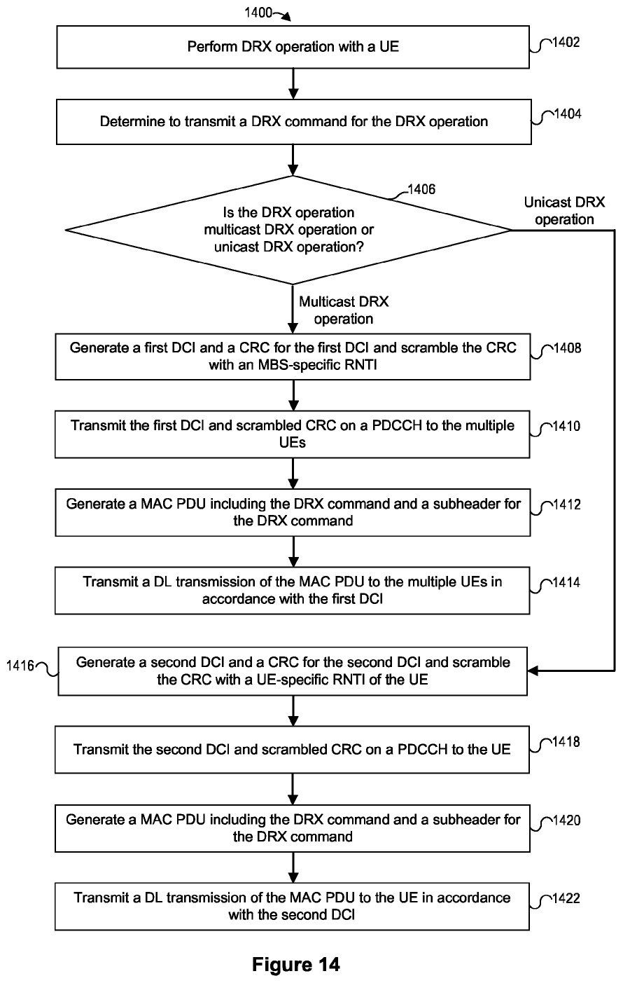

Referring next to FIG. 14, a method 1400 can be implemented in a suitable RAN and includes determining whether to generate a DCI and scramble a CRC according to an MBS-specific RNTI or a UE-specific RNTI based at least on whether the DRX operation is multicast or unicast. For clarity, the method 1400 is discussed with specific reference to the RAN 105, the BS 104, the CN 110, the UE 102, the PHY sublayer 202, and the MAC sublayer 204. Portions of method 1400 are similar to the techniques described in method 1300. In particular, blocks 1402, 1404, 1408, 1410, 1412 and 1414 are similar to blocks 1302, 1304, 1308, 1310, 1312, and 1314 of FIG. 13. As such, examples and implementations described in the blocks of FIG. 13 also apply to the corresponding blocks of FIG. 14.

At block 1402, the RAN 105 performs a DRX operation with a UE 102. In a minor difference with block 1302, this DRX operation does not have to be a multicast DRX operation with multiple UEs. At block 1404, the RAN 105 determines to transmit a DRX command for the DRX operation. At block 1406, the RAN 105 determines whether the DRX operation is a multicast DRX operation or a unicast DRX operation. If the DRX operation is a multicast DRX operation, then flow continues to blocks 1408, 1410, 1412, and 1414.

If the DRX operation is a unicast DRX operation, then flow instead proceeds to block 1416, where the RAN 105 generates a second DCI and a CRC for the second DCI. Rather than scrambling the CRC with an MBS-specific RNTI, however, the RAN 105 instead scrambles the CRC with a UE-specific RNTI for the UE 102, such as a C-RNTI or a CS-RNTI. At block 1418, the RAN 105 then transmits the second DCI and the scrambled CRC to the UE 102 (e.g., events 536 or 596 of FIGS. 5A-5F). In some implementations, the RAN 105 transmits the second DCI and the scrambled CRC to the UE 102 on a PDCCH. At block 1420, the RAN 105 then generates a data packet including the DRX command and a subheader for the DRX command, similar to block 1412. Subsequently, at block 1422, the RAN 105 transmits the data packet to the UE 102 in accordance with the second DCI (e.g., events 536 or 596 of FIGS. 5A-5F).

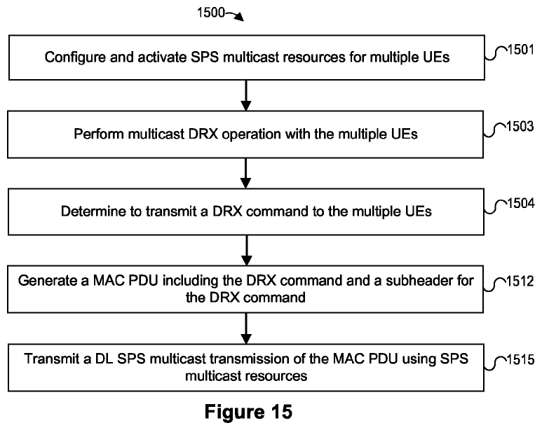

Referring next to FIG. 15, a method 1500 can be implemented in a suitable RAN and includes generating and transmitting a MAC PDU using SPS multicast resources. For clarity, the method 1500 is discussed with specific reference to the RAN 105, the BS 104, the CN 110, the UE 102, the PHY sublayer 202, and the MAC sublayer 204. Portions of method 1400 are similar to the techniques described in method 1300. In particular, blocks 1504 and 1512 are similar to blocks 1304 and 1312, respectively, of FIG. 13. As such, examples and implementations described in the blocks of FIG. 13 also apply to the corresponding blocks of FIG. 15.

At block 1501, the RAN 105 configures and/or activates SPS multicast resources for multiple UEs 102 (e.g., event 528, 594, or 595 of FIGS. 5A-5F). At block 1503, the RAN 105 performs multicast DRX operation with the multiple UEs 102 (e.g., event 536 or 596 of FIGS. 5A-5F). At block 1504, the RAN determines to transmit a DRX command to the UEs 102. At block 1512, the RAN 105 generates a data packet, such as a MAC PDU, including the DRX command and a subheader for the DRX command. At block 1515, the RAN 105 transmits the data packet to the UEs 102 using the configured SPS multicast resources.

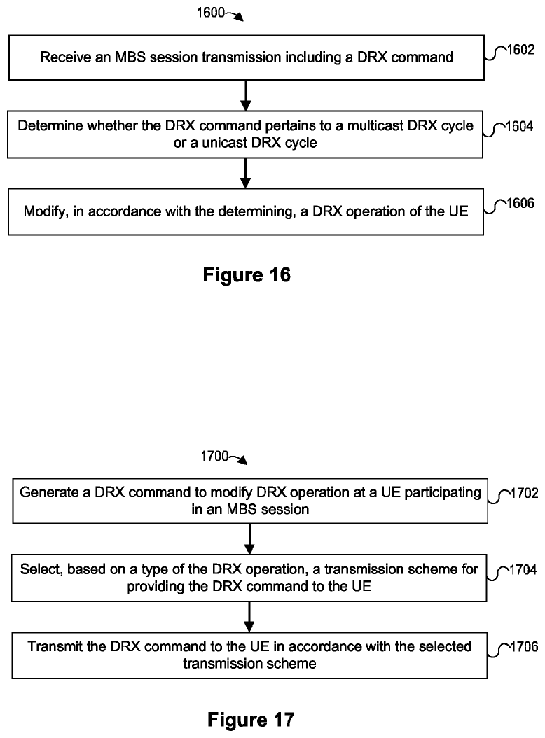

Referring next to FIG. 16, a method 1600 can be implemented in a suitable UE and includes managing DRX for an MBS session. For clarity, the method 1600 is discussed with specific reference to the RAN 105, the BS 104, the CN 110, the UE 102, the PHY sublayer 202, and the MAC sublayer 204.

At block 1602, the UE 102 receives, from a RAN 105, an MBS session transmission including a DRX command (e.g., events 536 or 596 and blocks 706/708, 806/808, 906, 1006, 1106, and 1204/1206 of FIGS. 5A-5F and 7-12). At block 1604, the UE 102 determines whether the DRX command pertains to a multicast DRX cycle or a unicast DRX cycle (e.g., blocks 704, 810, 904, 1012, and 1208 of FIGS. 7-10 and 12). At block 1606, the UE 102 modifies, in accordance with the determining, a DRX operation of the UE 102 (710, 812, 814, 1210, and 1212 of FIGS. 7, 8, and 12).

Referring next to FIG. 17, a method 1700 can be implemented in a suitable RAN and includes managing DRX for an MBS session. For clarity, the method 1700 is discussed with specific reference to the RAN 105, the BS 104, the CN 110, the UE 102, the PHY sublayer 202, and the MAC sublayer 204.

At block 1702, the RAN 105 generates a DRX command to modify DRX operation at a UE 102 participating in an MBS session (e.g., blocks 1312, 1412/1420, and 1512 of FIGS. 13-15). At block 1704, the RAN 105 selects, based on a type the DRX operation, a transmission scheme for providing the DRX command to the UE 102 (e.g., blocks 1308, 1408/1416, and 1515 of FIGS. 13-15). At block 1706, the RAN 105 transmits the DRX command to the UE 102 in accordance with the selected transmission scheme (e.g., events 536 or 596 and blocks 1314, 1414, 1422, and 1515 of FIGS. 5A-5F and 13-15).

The following list of examples reflects a variety of the embodiments explicitly contemplated by the present disclosure:

Example 1. A method for managing discontinuous reception (DRX) for a multicast and broadcast services (MBS) session, the method implemented in a user equipment (UE) and comprising: receiving, by processing hardware, an MBS session transmission including a DRX command; determining, by the processing hardware, whether the DRX command pertains to a multicast DRX cycle or a unicast DRX cycle; and modifying, by the processing hardware and in accordance with the determining, a DRX operation of the UE.

Example 2. The method of example 1, further comprising: receiving, from the RAN, a cyclic redundancy check (CRC) associated with the DCI and scrambled by a radio network temporary identifier (RNTI); wherein determining whether the DRX command pertains to the multicast DRX cycle or the unicast DRX cycle is based on at least whether the RNTI is an MBS-specific RNTI.

Example 3. The method of example 2, wherein modifying the DRX operation of the UE includes: stopping an on-duration period of the multicast DRX cycle when the RNTI is an MBS-specific RNTI.

Example 4. The method of example 2, wherein modifying the DRX operation of the UE includes: stopping an on-duration period of the unicast DRX cycle when the RNTI is not an MBS-specific RNTI.

Example 5. The method of example 3 or 4, including: determining that the RNTI is an MBS-specific RNTI when the RNTI is a G-RNTI or a G-CS-RNTI, and determining that the RNTI is not an MBS-specific RNTI when the RNTI is a C-RNTI or a CS-RNTI.

Example 6. The method of example 1, wherein determining whether the DRX command pertains to the multicast DRX cycle or the unicast DRX cycle includes: determining whether the MBS session transmission including the DRX command was received via a multicast transmission or a unicast transmission.

Example 7. The method of example 6, wherein receiving the MBS session transmission includes: receiving, at an upper layer of the UE, a medium access control packet including the DRX command; and retrieving the DRX command from the medium access control packet.

Example 8. The method of any of the preceding examples, wherein receiving the MBS session transmission includes: sending, from a physical layer to an upper layer, a medium access control packet including a multicast indication.

Example 9. The method of example 8, further comprising: determining whether to transmit a transmission type indication to the upper layer based on whether a transmission type indication function is enabled at the physical layer of the UE.

Example 10. The method of example 9, wherein the transmission type indication indicates multicast.

Example 11. The method of example 10, further comprising: transmitting the transmission type indication indicating multicast to the upper layer when the MBS session transmission is a multicast transmission; and refraining from transmitting the transmission type indication to the upper layer when the MBS session transmission is not a multicast transmission.

Example 12. The method of example 10, further comprising: transmitting the transmission type indicator indicating multicast to the upper layer when the MBS session transmission is a multicast transmission; and transmitting the transmission type indicator indicating unicast indication to the upper layer when the MBS session transmission is not a multicast transmission.

Example 13. The method of example 9, wherein the transmission type indication indicates unicast.

Example 14. The method of example 13, further comprising: transmitting the transmission type indicator indicating unicast to the upper layer when the MBS session transmission is a unicast transmission; and refraining from transmitting the transmission type indication to the upper layer when the MBS session transmission is not a unicast transmission.

Example 15. The method of any of examples 2 or 6-14, wherein modifying the DRX operation of the UE includes stopping an on-duration operation.

Example 16. A user equipment (UE) comprising processing hardware and configured to implement a method according to any of examples 1-15.

Example 17. A method for managing discontinuous reception (DRX) for a multicast and broadcast services (MBS) session, the method implemented in a radio access network (RAN) and comprising: generating, by processing hardware, a DRX command to modify DRX operation at a UE participating in an MBS session; selecting, by the processing hardware and based on a type of the DRX operation, a transmission scheme for providing the DRX command to the UE; and transmitting, by the processing hardware, the DRX command to the UE in accordance with the selected transmission scheme.

Example 18. The method of example 17, wherein selecting the transmission scheme includes: transmitting the DRX command using an MBS-specific RNTI when the type of DRX operation is multicast.

Example 19. The method of example 17, wherein selecting the transmission scheme includes: transmitting the DRX command using a UE-specific RNTI when the type of DRX operation is unicast.

Example 20. The method of example 17, wherein the type of DRX operation is multicast and the UE is a first of a plurality of UEs, further comprising: generating a DCI and a CRC for the DCI; scrambling the CRC using the MBS-specific RNTI; and transmitting the DCI and the scrambled CRC to the plurality of UEs; wherein transmitting the DRX command is in accordance with the DCI.

Example 21. The method of example 18, wherein the type of DRX operation is unicast, further comprising: generating a DCI and a CRC for the DCI; scrambling the CRC using the UE-specific RNTI; and transmitting the DCI and the scrambled CRC to the UE; wherein transmitting the DRX command is in accordance with the DCI.

Example 22. The method of any of examples 18-21, including: determining that the RNTI is an MBS-specific RNTI when the RNTI is a G-RNTI or a G-CS-RNTI, and determining that the RNTI is not an MBS-specific RNTI when the RNTI is a C-RNTI or a CS-RNTI.

Example 23. The method of any examples 17-22, wherein transmitting the DRX command includes: transmitting a subheader for the DRX command including an indication of the type of DRX operation.

Example 24. The method of example 17, wherein the type of DRX operation is one of at least multicast or unicast.

Example 25. The method of example 17, wherein selecting the transmission scheme includes: configuring SPS multicast resources for the UE when the type of DRX operation is multicast; and transmitting the DRX command to the UE using the SPS multicast resources.

Example 26. A radio access network (RAN) node comprising processing hardware and configured to implement a method according to any of examples 17-25.

The following additional considerations apply to the foregoing discussion.

Generally speaking, description for one of the above figures can apply to another of the above figures. An event or block described above can be optional or omitted. For example, an event or block with dashed lines in the figures can be optional or omitted. In some cases, an event or block with solid lines in the figures can still be optional or omitted if the event or block is not necessary. In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”. In some implementations, “SPS multicast” can be replaced by “multicast SPS”. Similarly, “dynamic scheduling multicast” can be replaced by “multicast dynamic”. In some implementations, “identifier” can be replaced by “identity”. In some implementations, “CFR” is used and can be replaced by “MBS BWP”. In some implementations, the term “transport layer configuration” can be replaced by “tunnel information” or “transport layer information”.

A user device in which the techniques of this disclosure can be implemented (e.g., the UE 102A, 102B, or UE 103) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for performing a HARQ process to transmit MBS data through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method for managing discontinuous reception (DRX) for a multicast and broadcast services (MBS) session, the method implemented in a user equipment (UE) and comprising:
receiving an MBS session transmission including a DRX command associated with a radio network temporary identifier (RNTI);
determining whether the DRX command pertains to a multicast DRX cycle or a unicast DRX cycle based on the RNTI; and
stopping, in accordance with the determining, a timer associated with an on-duration period of the multicast DRX cycle.

2. The method of claim 1, wherein determining whether the DRX command pertains to a multicast DRX cycle or a unicast DRX cycle based on the RNTI includes:
determining whether the DRX command pertains to a multicast DRX cycle based on whether the RNTI is an MBS-specific RNTI
wherein the stopping the timer occurs when the RNTI is an MBS-specific RNTI.

3. The method of claim 1, wherein modifying the DRX operation of the UE further includes:
stopping an on-duration period of the unicast DRX cycle when the RNTI is not an MBS-specific RNTI.

4. The method of claim 2, including:
determining that the RNTI is an MBS-specific RNTI when the RNTI is a G-RNTI or a G-CS-RNTI, and
determining that the RNTI is not an MBS-specific RNTI when the RNTI is a C-RNTI or a CS-RNTI.

5. The method of claim 1, wherein receiving the MBS session transmission includes:
sending, from a physical layer to an upper layer, a medium access control packet including a multicast indication.

6. The method of claim 5, further comprising:
determining whether to transmit a transmission type indication to the upper layer based on whether a transmission type indication function is enabled at the physical layer of the UE.

7. The method of claim 6, wherein the transmission type indication indicates multicast, the method further comprising:
transmitting the transmission type indication indicating multicast to the upper layer when the MBS session transmission is a multicast transmission; and
refraining from transmitting the transmission type indication to the upper layer when the MBS session transmission is not a multicast transmission.

8. The method of claim 6, wherein the transmission type indication indicates unicast, the method further comprising:
transmitting the transmission type indicator indicating unicast to the upper layer when the MBS session transmission is a unicast transmission; and
refraining from transmitting the transmission type indication to the upper layer when the MBS session transmission is not a unicast transmission.

9. The method of claim 1, wherein the timer is a drx-onDurationTimerPTM timer.

10. (canceled)

11. A method for managing discontinuous reception (DRX) for a multicast and broadcast services (MBS) session, the method implemented in a radio access network (RAN) and comprising:
generating a DRX command associated with a radio network temporary identifier (RNTI), the DRX command to stop a timer associated with an on-duration period of a multicast DRX cycle based on the RNTI;
selecting, based on a type of the DRX operation, a transmission scheme for providing the DRX command to the UE; and
transmitting the DRX command to the UE in accordance with the selected transmission scheme.

12. The method of claim 11, wherein selecting the transmission scheme includes:
transmitting the DRX command using an MBS-specific RNTI when the type of DRX operation is multicast.

13. The method of claim 11, wherein selecting the transmission scheme includes:
transmitting the DRX command using a UE-specific RNTI when the type of DRX operation is unicast.

14. The method of claim 11, including:
determining that the RNTI is an MBS-specific RNTI when the RNTI is a G-RNTI or a G-CS-RNTI, and
determining that the RNTI is not an MBS-specific RNTI when the RNTI is a C-RNTI or a CS-RNTI.

15. The method of claim 11, wherein transmitting the DRX command includes:
transmitting a subheader for the DRX command including an indication of the type of DRX operation.

16. The method of claim 11, wherein selecting the transmission scheme includes:
configuring SPS multicast resources for the UE when the type of DRX operation is multicast; and
transmitting the DRX command to the UE using the SPS multicast resources.

17. (canceled)

18. An apparatus, operating as a user equipment (UE) and configured to manage discontinuous reception (DRX) for a multicast and broadcast services (MBS) session, the apparatus comprising:
processing hardware configured to:
receive an MBS session transmission including a DRX command associated with a radio network temporary identifier (RNTI);
determine whether the DRX command pertains to a multicast DRX cycle or a unicast DRX cycle based on the RNTI; and
stop, in accordance with determining whether the DRX command pertains to the multicast DRX cycle or the unicast DRX cycle, a timer associated with an on-duration period of the multicast DRX cycle

19. The apparatus of claim 18, wherein determining whether the DRX command pertains to a multicast DRX cycle or a unicast DRX cycle based on the RNTI includes:
determining whether the DRX command pertains to a multicast DRX cycle based on whether the RNTI is an MBS-specific RNTI
wherein stopping the timer occurs when the RNTI is an MBS-specific RNTI.

20. The apparatus of claim 18, wherein modifying the DRX operation of the UE further includes:
stopping an on-duration period of the unicast DRX cycle when the RNTI is not an MBS-specific RNTI.

21. The apparatus of claim 19, wherein the processing hardware is further configured to:
determine that the RNTI is an MBS-specific RNTI when the RNTI is a G-RNTI or a G-CS-RNTI, and
determine that the RNTI is not an MBS-specific RNTI when the RNTI is a C-RNTI or a CS-RNTI.

22. The apparatus of claim 18, wherein receiving the MBS session transmission includes:
sending, from a physical layer to an upper layer, a medium access control packet including a multicast indication.
